(19) United States
(12) Patent Application Publication
(10) Pub. No.: US 2016/0005257 A1
(43) Pub. Date: Jan. 7, 2016

(54) INFLUENCE SYSTEM AND METHODS

(71) Applicants: James Logston, Gainesville, FL (US); Philip Asher, Gainesville, FL (US)

(72) Inventors: James Logston, Gainesville, FL (US); Philip Asher, Gainesville, FL (US)

(73) Assignee: TRENDY ENTERTAINMENT, GAINESVILLE, FL (US)

(21) Appl. No.: 14/750,424

(22) Filed: Jun. 25, 2015

Related U.S. Application Data
(60) Provisional application No. 62/021,072, filed on Jul. 4, 2014.
(60) Provisional application No. 62/060,128, filed on Oct. 6, 2014.

(51) Int. Cl. G07F 17/32

(52) U.S. Cl. CPC G07F 17/323

(57) ABSTRACT

Examples disclosed herein relate to a system, device, and/or method for funding on one or more projects including: one or more memory devices; one or more processors configured to receive at least a first project, the one or more processors configured to present the first project to a funding community, the one or more processors configured to receive one or more funding pledges relating to the first project from one or more members of the funding community, the one or more processors configured to determine a status of the first project based on the received pledged funds.

### CROSS-REFERENCE TO RELATED PATENT APPLICATION

This application claims priority to Provisional Patent Application No. 62/021,072 entitled “CROSS-PLATFORM DIGITAL DISTRIBUTATION AND GAME SERVER HOSTING SYSTEM”, filed on Jul. 4, 2014, and this application claims priority to Provisional Patent Application No. 62/060,128 entitled “INFLUENCE SYSTEM AND METHODS”, filed on Oct. 6, 2014, which are incorporated herein by reference in their entireties.

### BACKGROUND

### Field

The subject matter disclosed herein relates to systems, devices, and/or methods for influencing and funding projects in a community setting (e.g., physical, virtual, and/or a combination thereof). More specifically, the disclosure relates to providing one or more influencing and/or funding functions for devices, for any products, and/or for any services (e.g., clothing, cars, accounting, dry cleaning, travel, food, etc.).

### BRIEF DESCRIPTION OF THE FIGURES

Non-limiting and non-exhaustive examples will be described with reference to the following figures, wherein like reference numerals refer to like parts throughout the various figures.

FIG. 1A is an illustration of the electronic gaming device, according to one embodiment.

FIG. 1B is an illustration of another electronic gaming device, according to one embodiment.

FIG. 1C is an illustration of another electronic gaming device, according to one embodiment.

FIG. 1D is an illustration of another electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of game play on a gaming device, according to one embodiment.

FIG. 5B is an illustration of an influence procedure for a product, according to one embodiment.

FIG. 5C is an illustration of an influence procedure for a product, according to one embodiment.

FIG. 6A is another illustration of an influence procedure on a gaming device, according to one embodiment.

FIG. 6B is another illustration of an influence procedure for a product, according to one embodiment.

FIG. 6C is another illustration of an influence procedure for a product, according to one embodiment.

FIG. 6D is another illustration of an influence procedure for a product, according to one embodiment.

FIG. 7A is another illustration of an influence procedure and/or funding procedure for a product, according to one embodiment.

FIG. 7B is another illustration of an influence procedure and/or funding procedure for a product, according to one embodiment.

FIG. 7C is another illustration of an influence procedure and/or funding procedure for a product, according to one embodiment.

FIG. 7D is another illustration of an influence procedure and/or funding procedure for a product, according to one embodiment.

FIG. 8A is another illustration of an influence procedure for a product, according to one embodiment.

FIG. 8B is another illustration of an influence procedure for a product, according to one embodiment.

FIG. 8C is another illustration of an influence procedure for a product, according to one embodiment.

FIG. 9 is a flow diagram, according to one embodiment.

FIG. 10A is an illustration of earning votes and/or influence criteria, according to one embodiment.

FIG. 10B is another illustration of earning votes and/or influence criteria, according to one embodiment.

FIG. 10C is another illustration of earning votes and/or influence criteria, according to one embodiment.

FIG. 11 is a flow diagram, according to one embodiment.

FIG. 12 is a flow diagram, according to one embodiment.

FIG. 13 is a flow diagram, according to one embodiment.

FIG. 14 is a flow diagram, according to one embodiment.

FIG. 15A is another illustration of a funding procedure for a product, according to one embodiment.

FIG. 15B is another illustration of a funding procedure for a product, according to one embodiment.

FIG. 15C is another illustration of a funding procedure for a product, according to one embodiment.

FIG. 16 is a flow diagram, according to one embodiment.

FIG. 17 is a flow diagram, according to one embodiment.

FIG. 18 is a flow diagram, according to one embodiment.

FIG. 19 is a flow diagram, according to one embodiment.

FIG. 20 is a flow diagram, according to one embodiment.

FIG. 21 is a flow diagram, according to one embodiment.

FIG. 22 is a flow diagram, according to one embodiment.

FIG. 23 is a flow diagram, according to one embodiment.

### DETAILED DESCRIPTION

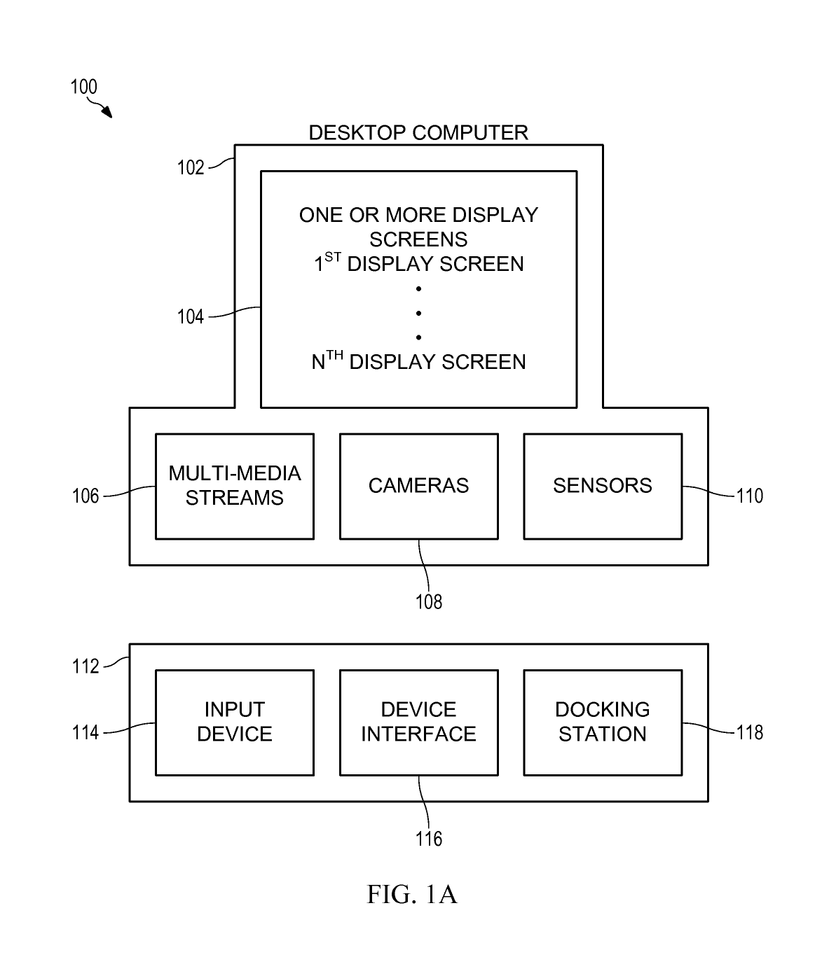

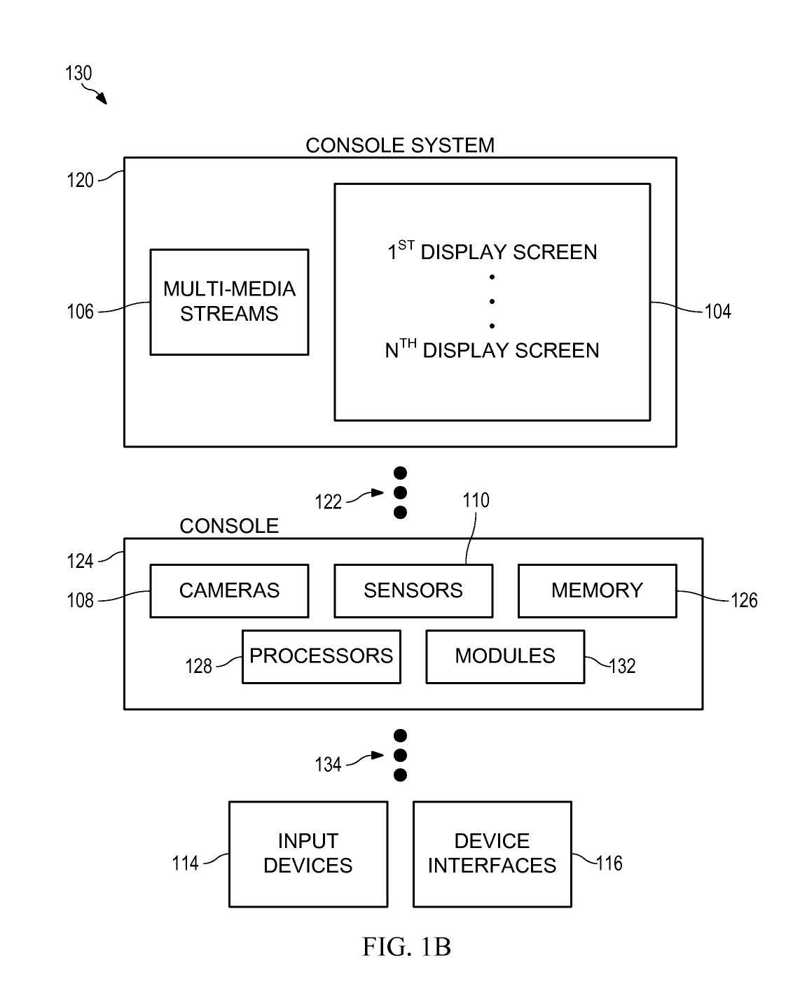

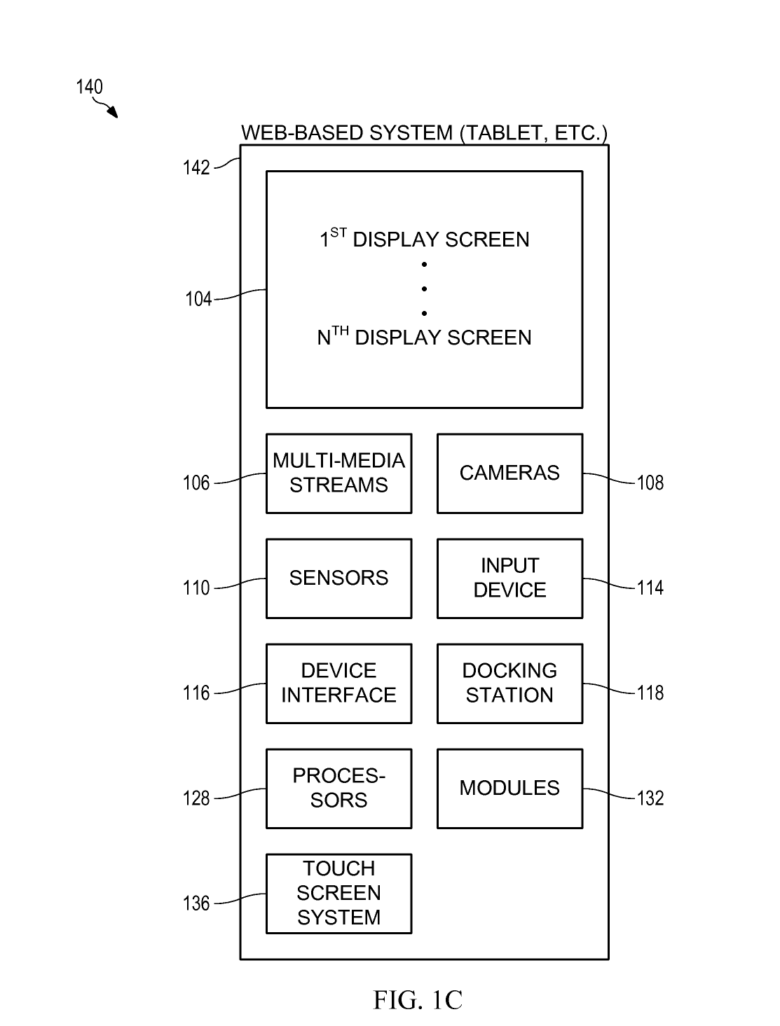

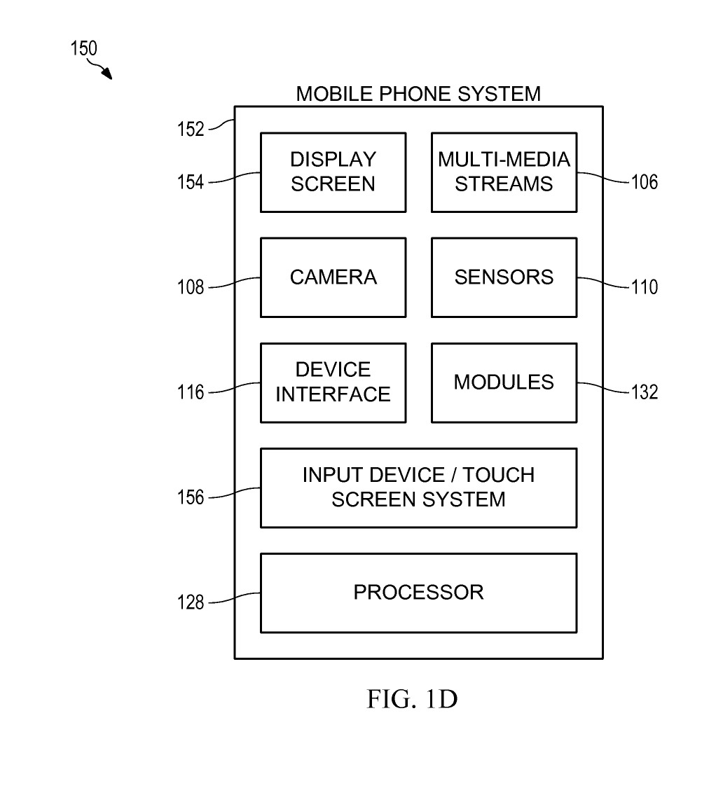

FIG. 1A is an illustration of an electronic gaming device 100 (e.g., desktop computer 102). Electronic gaming device 100 may include a multi-media stream 106, and/or one or more display screens 104 (e.g., a first display screen, a second display screen, a third display screen, an nth display screen, etc.). A controller 112 may include one or more input devices 114, a device interface 116, and/or a docking station 118. Further, the gaming system may include one or more cameras 108 and/or one or more sensors 110. Electronic gaming device 100 may display one, two, a few, or a plurality of multi-media streams 106, which may be obtained from one or more gaming devices, a central server, a video server, a music server, an advertising server, another data source, and/or any combination thereof.

Multi-media streams may be obtained for an entertainment event, a promotional event, a promotional offering, an advertisement, a sporting event, any other event, and/or any combination thereof. For example, the entertainment event may be a concert, a show, a television program, a movie, an Internet event, and/or any combination thereof. In another example, the video streams may be feeds from other players' playing the game, the electronic gaming device 100 the person is playing on, any other game, and/or any combination thereof. For example, a first player may be playing a first game with four other players on his team and have feeds from one or more of the other four players shown on a portion of a display screen. In another example, the video feeds might be from other players playing a second game and/or the first game. In another example, a car race and/or any other race can be utilized. For example, a NASCAR race may be occurring while the player is playing the first game and the player wants to do both (e.g., play the first game and watch the race).

The advertisement may be an advertisement for a new game, a new game feature, a voting opportunity, a funding opportunity, a restaurant, a shop, any other entity, to preorder a game and/or game feature, a contest, the leaderboard, to recruit player to a team, selling, buying, and/or trading items, to request items, and/or any combination thereof. The sporting event may be a football game, a baseball game, a hockey game, a basketball game, any other sporting event, and/or any combination thereof. These multi-media streams may be utilized in combination with the other gaming device video streams.

Input device 114 may be mechanical buttons, electronic buttons, mechanical switches, electronic switches, optical switches, a keyboard, a keypad, a touch screen, a gesture screen, a joystick, a pointing device (e.g., a mouse), a virtual (on-screen) keyboard, a virtual (on-screen) keypad, biometric sensor, or any combination thereof.

Device interface 116 may be utilized to interface electronic gaming device 100 to a peripheral display device, signage, a promotional device, network components, a local network, a wide area network, remote access equipment, a game monitoring system, a player tracking system, the Internet, a server, and/or any combination thereof.

Display screens may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology.

One or more cameras 108 and/or one or more sensors 110 may be utilized as one or more depth image sensing devices, which may be located in various locations, including but not limited to, above the base display, above second display, in one or more locations on gaming device front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may also include one or more speakers. In various examples, any of the description related to FIG. 1A can be utilized with a desktop computer, a console (FIG. 1B), a web-based system (FIG. 1C), and/or a mobile device (FIG. 1D).

FIG. 1B is an illustration of a console system 130. Console system 130 may include a multi-media stream 106, one or more display screens 104 (e.g., a first display screen, a second display screen, a third display screen, an nth display screen, etc.), an input device 114, a device interface 116, and a console device 124. Console device 124 may include one or more cameras 108, one or more sensors 110, memory devices 126, one or more processors 128, and/or one or more modules 132. In various examples, the communication links 122 and 134 may communicate via a wired connection, a wireless connection, and/or any combination thereof.

FIG. 1C is an illustration of a web-based system 140. Web-based system 140 may include a multi-media stream 106, one or more display screens 104 (e.g., a first display screen, a second display screen, a third display screen, a side display screen, etc.), one or more cameras 108, one or more sensors 110, an input device 114, a device interface 116, a docking station 118, one or more processors 128, one or more modules 132, and/or one or more touch screen systems 136.

FIG. 1D is an illustration of a mobile phone system 150. Mobile phone system 150 may include a multi-media stream 106, a display screen 154, an input device/touch screen system 156, a device interface 116, one or more cameras 108, one or more sensors 110, one or more processors 128, and/or one or more modules 132.

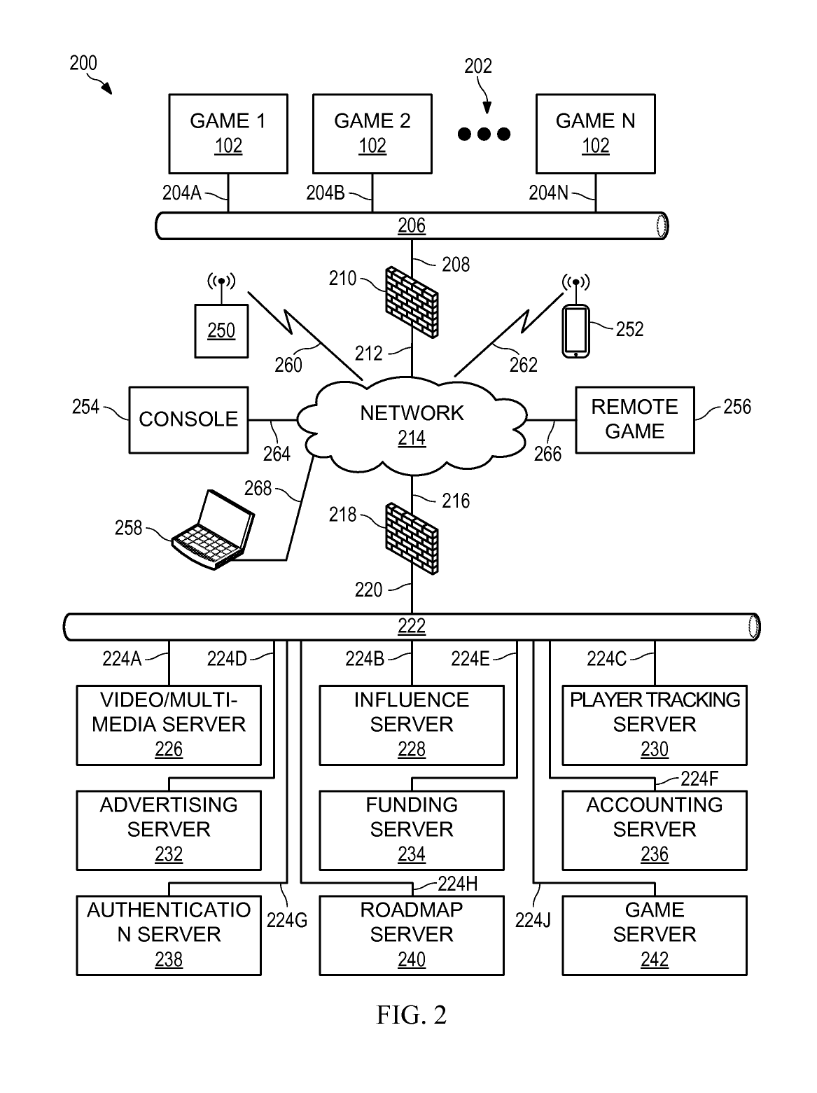

In FIG. 2, an electronic gaming system 200 is shown. Electronic gaming system 200 may include a video/multimedia server 226, an influence server 228, a player tracking server 230, an advertising server 232, a funding server 234, an accounting server 236, an authentication server 238, a roadmap server 240, and/or a game server 242.

Electronic gaming system 200 may include video/multimedia server 226, which may be coupled (via a buss 222, an internal link 220, and/or a firewall 218) to network 214 via a network link 216. Network 214 may be the Internet, a private network, and/or a network cloud. One or more video streams may be received at video/multimedia server 226 from other electronic gaming devices 100. Video/multimedia server 226 may transmit one or more of these video streams to a mobile phone 252, electronic gaming device 100, a remote electronic gaming device at a different location, a remote electronic gaming device 256, a laptop 258, and/or a game console 254. Video/multimedia server 226 may transmit these video streams via network link 216 and/or network 214.

Gaming server 242 may generate and/or monitor gaming outcomes. Gaming server 242 may provide electronic gaming device 100 with game play content. Gaming server 242 may provide electronic gaming device with game play math and/or outcomes. Gaming server 242 may provide one or more of: basic game feature functionality; enhanced game feature functionality; enhanced game feature functionality based on voting history; enhanced game feature functionality based on funding history; enhanced game feature functionality based on purchasing history, enhanced game feature functionality based on usage history, enhanced game feature functionality based on a combination of voting history, funding history, usage history, and/or purchasing history, other game functionality, and/or any other virtual game functionality.

Player tracking server 230 may track a player's funding activity, a player's preferences (e.g., language, font, sound level, etc.), voting activity, purchasing activity, submission activity, etc. Based on data obtained by player tracking server 230, a player may be eligible for gaming rewards (e.g., free shirts), promotions, and/or other awards (e.g., special game features, etc.). For example, after a player completes their voting, funding, purchasing, usage, and/or any other criteria, the player may receive a bonus feature in a game, a tee shirt, a gaming coupon, virtual currency, project currency, and/or any other item, and/or any other service. In another example, after a player completes a first level of voting, funding, purchasing, usage, and/or any other criteria (e.g., 10 votes, $100 in funding, 50 hours of play, $1,000 in purchases, etc.), then the player may receive a bonus and/or item of value. In another example, after a player completes a second level (and/or nth level) of voting, funding, purchasing, usage, and/or any other criteria, the player may receive a higher bonus and/or item of value.

Authentication server 238 may determine the validity of the player's identity. For example, a player identity may need to be confirmed before a funding pledge may be accepted by the player. This may be completed via a password and/or any other validation means.

Accounting server 236 may compile, track, and/or monitor cash flows and/or other transaction data. Transaction data may include the number of votes, the size of any funding, the date and time for these fundings, the identity of the players making these fundings and/or votes, the frequency of the voting and/or funding, and/or verification data, and/or confirmation data, and/or followers data, and/or grouping data, and/or group data. Accounting server 236 may generate tax information relating to these fundings. Accounting server 236 may generate profit/loss reports for funding, voting, purchasing, usage, and/or any other activity. In one example, project X may have been successfully funded at a projected cost of $1,000,000. However, project X's total cost was $1,050,000. Therefore, a total loss of $50,000 was recorded. In another example, project X was funded at $1,000,000 and cost a total of $1,000,000. However, the functionality of project X actually increased sales by 25% or 10 million dollars. In another example, the functionality of project X actually decreased sales by 2% or $400,000 in revenue. In another example, an advertisement may have a success rate of 10% and a closure rate of 2% which has a value of $100,000 while the advertisement cost was $5,000. In one example, the funders may receive a percentage of the profits generated by a funded and/or submitted idea. In another example using one or more of the accounting server, tracking system, and/or statics system, the system, device, and/or method may determine that when a player utilizes and/or play for 5 hours a day that player is 4 times more like to purchase an add-on item.

Network connection (reference numbers 216, 220, 260, etc.) may be used for communication between dedicated servers, thin clients, thick clients, back-office accounting systems, etc.

Laptop computer 258 and/or any other electronic devices (e.g., mobile phone 252, electronic gaming device 100, etc.) may be used for downloading new gaming device applications or gaming device related firmware through remote access. Laptop computer 258 and/or any other electronic device (e.g., mobile phone 252, electronic gaming device 100, etc.) may be used for uploading accounting information.

Network 214 may be a local area network, a player's network, a wide area network, a virtual private network, an enterprise private network, the Internet, or any combination thereof. Hardware components, such as network interface cards, repeaters and hubs, bridges, switches, routers, firewalls, or any combination thereof may also be part of network 214.

A statistics server may be used to maintain data relating to historical game play, individual voting data, group voting data, follower voting data, individual funding date, group funding data, follower funding data, individual purchasing data, group purchasing data, follower purchasing data, individual usage data, group usage data, follower usage data, individual idea submissions, group submissions, follower submissions, and/or any other gaming, player, group, follower, and/or event data. This historical data may include funding amounts, voting numbers, voting time, funding time, purchase amount, purchase quantity, discounts, playing time, service usage time, playing frequency, service frequency, and/or any other data relating to any game, device, product, and/or service.

Searching server may implement a search on one or more gaming devices to obtain gaming data. Searching server may implement a messaging function, which may transmit a message to a third party (e.g., a player) relating to a search, a search status update, a game status update, a funding status update, a voting status update, confirmation of a wager, a confirmation of a money transfer, and/or any other data relating to the player's account. The message can take the form of a text display on the gaming device, a pop up window, a text message, an email, a voice message, a video message and the like. Searching server may implement a voting (and/or funding) function, which may be an automatic mechanism. These functions of searching server 232 may be integrated into one or more servers. In one example, a search results could state “Your friends X, Y, and Z have all voted and/or funded projects A and B. Do you want to vote for these projects too?” In another example, the search results could state “Your friends are using C and D, do you want to use C and/or D too?”

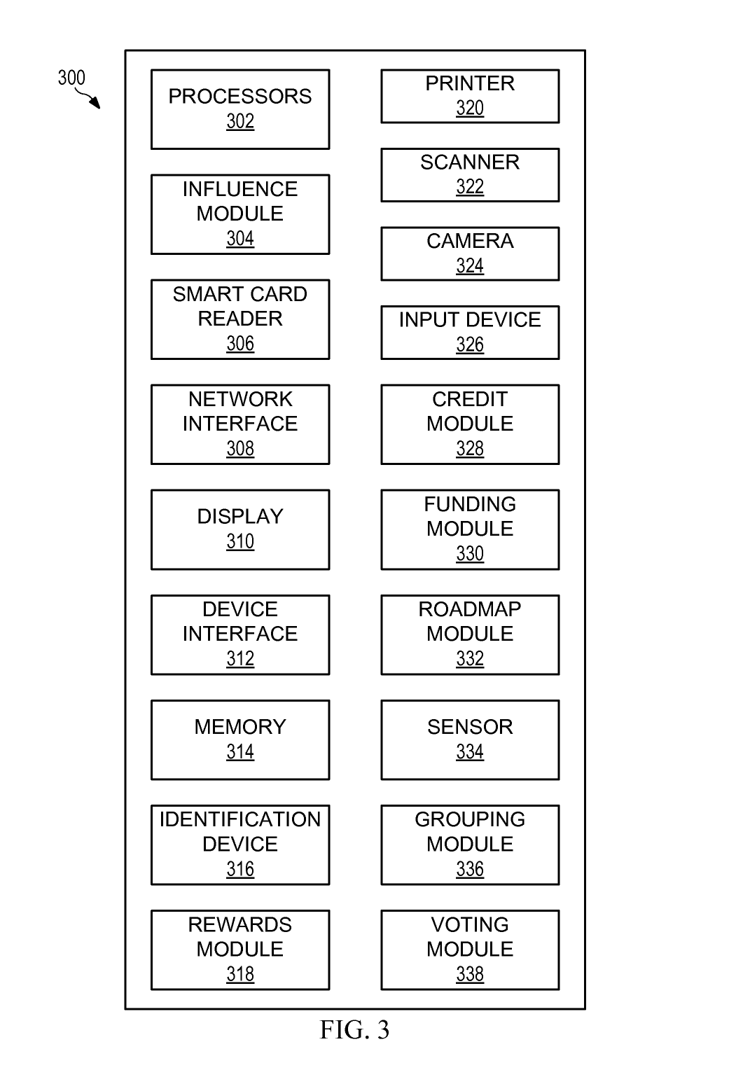

FIG. 3 shows a block diagram 300 of electronic gaming device. Electronic gaming device may include a processor 302, an influence module 304, a smart card reader 306, a network interface 308, a display 310, a device interface 312, a memory 314, an identification device 316, a rewards module 318, a printer 320, a scanner 322, a camera 324, an input device 326, a credit module 328, a funding module 330, a roadmap module 332, a sensor 334, a grouping module 336, and/or a voting module 338.

Processor 302 may execute program instructions of memory 314 and use memory 314 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 314 to access a player's mobile device through device interface 312 to display contents onto display 310. Memory 314 may include communication interfaces for communicating with electronic gaming device 100, electronic gaming system 200, and user interfaces to enable communication with all gaming elements. For example, the information stored on memory 314 may be printed out. Videos or pictures captured by camera 324 may be saved and stored on memory 314. Memory 314 may include a confirmation module, which may authenticate any data relating to purchases, usage, game play, the player, the game, any voting data, and/or any funding data. Processor 302 may determine the value of the voucher based on generated voucher data and data in the confirmation module. Electronic gaming device 100 may include a player preference input device. The player preference input device may modify a game configuration. The modification may be based on data from the identification device.

Memory 314 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 314 may also be volatile semiconductor memory such as, dynamic random access memory (“DRAM”), static random access memory (“SRAM”), and/or any combination thereof.

Memory 314 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 314 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 316 to verify the identity of a player.

Printer 320 may be used for printing receipts, non-gaming coupons, game coupons, advertising promotions, funding confirmation, and/or any combination thereof.

Network interface 308 may allow electronic gaming device 100 to communicate with video/multimedia server 226, gaming server, player tracking server, voucher server, authentication server, and/or accounting server.

Input device 326 may be mechanical buttons, electronic buttons, a touch screen, and/or any combination thereof.

Display 310 may show video streams from one or more content sources. Display 310 may encompass first display screen, second display screen, third display screen, side display screen, an Nth screen, and/or another screen used for displaying video content.

Credit module 328 may be utilized to collect monies and distribute monies (e.g., cash, vouchers, etc.). Credit device 328 may interface with processor 302 to complete funding options, voting options, purchases, generate and/or distribute cash prizes, distribute cash, distribute virtual currency, distribute project currency, and/or any combination thereof.

Electronic gaming device 100 may include a device interface that a user may employ with his or her mobile device (e.g., smart phone) to receive information from and/or transmit information to electronic gaming device 100 (e.g., watch a movie, listen to music, verify identification, transmit credits, etc.).

Identification device 316 may be utilized to allow electronic gaming device 100 to determine an identity of a player. Based on information obtained by identification device 316, electronic gaming device 100 may be reconfigured. For example, the language, sound level, music, placement of video streams, placement of images, placement of gaming options, and/or the streams utilized may be modified based on player preference data.

For example, a player may have selected a specific baseball team (e.g., Florida Marlins) under the sporting event preferences, the electronic gaming device 100 will then automatically (or via player input) display the current baseball game (e.g., Florida Marlins vs. New York Mets) onto a display screen as set in the player's options.

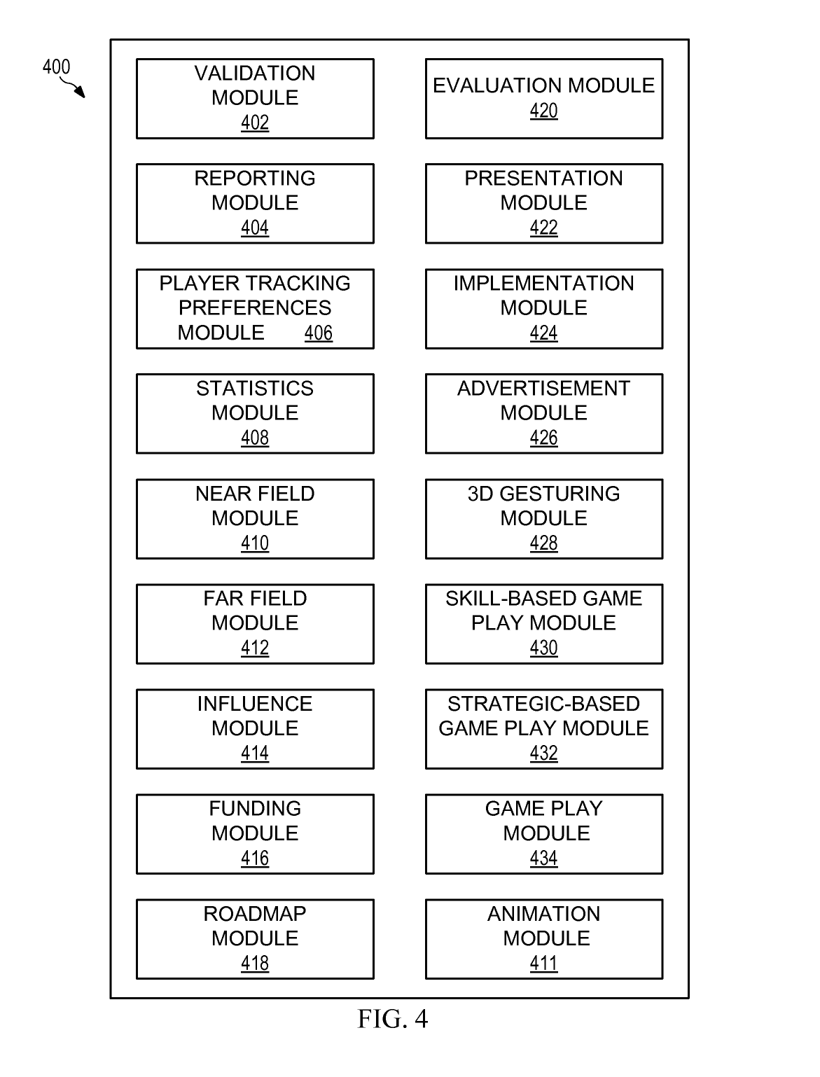

FIG. 4 shows a block diagram of memory 400, which includes various modules. Memory 400 may include a validation module 402, a reporting module 404, a player tracking preferences module 406, a statistics module 408, a near field module 410, an animation module 411, a far field module 412, an influence module 414, a funding module 416, a sensor module, a scene module, a sensor and scene evaluation module, a sensor and scene output module, a reference models module, an audio module, a roadmap module 418, a game evaluation module 420, a presentation module 422, an implementation module 424, a tracking module, a signage module, an advertisement module 426, a 3D gesturing module 428, a skill-based module 430, a mobile device module, a strategic-based game play module 432, a game play module 434, and a game configuration module.

Validation module 402 may utilize data to confirm the validity of voting data, funding data, usage data, player data, gaming data, purchasing data, group data, follower data, trading data, and/or any other information relating to the systems, devices, and/or method disclosed in this disclosure. For example, a 3D gesturing module 428 may be utilized to allow the player/user to play a game, make a purchase, vote for one of more projects, and/or fund one or more projects which may be validated by the validation module 402.

Reporting module 404 may generate reports related to a performance of electronic gaming device 100, electronic gaming system 200, video streams, gaming objects, funding activities, voting data, funding data, usage data, player data, gaming data, purchasing data, group data, follower data, trading data, and/or any other information relating to the systems, devices, and/or method disclosed in this disclosure. For example, the system, device, and/or method may track trading data where it may be observed that X item is the most popular traded item —a list of top traded items and/or a history of items traded may be compiled, distributed, and/or displayed.

Player tracking preferences module 406 may compile and track data associated with a player's preferences. For example, the system, device, and/or method may determine that males in the 22-25 age group prefer by 80% to 20% item Z (e.g., a virtual weapon, product X, service Y, etc.). In another example, women in the 30-35 age group prefer (e.g., 70%) to buy product Z by procedure A. In another example, a first male age group purchases a first product type during a first time period during the day while a first female age group purchases the first product type during a second time period during the day.

Animation module 411 may generate, compile, transmit, and/or store one or more animations and/or presentations based on one or more scene data, one or more scenes, one or more reference models, one or more game play data, one or more player profiles, and/or any combination thereof.

Game evaluation module 420 may evaluate one or more outcomes for one or more events relating to game play.

Sensor module may generate, compile, transmit, and/or store any data relating to one or more scene data, one or more scene, and/or any other sensor data. This data may include one or more gestures (e.g., body movement made by one or more players). Scene module may generate, compile, transmit, and/or store on one or more scene data, one or more scenes, one or more reference models, one or more game play data, one or more player profiles, and/or any combination thereof. Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions. Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules. Audio module may generate, compile, transmit, and/or store one or more audio structures, sound wave configurations, and/or any other audio data.

Statistics module 408 may be used to maintain data relating to historical game play, voting activities, funding activities, voting data, funding data, usage data, player data, gaming data, purchasing data, group data, follower data, trading data, and/or any other information relating to the systems, devices, and/or method disclosed in this disclosure.

Near field game module 410 may generate, transmit, compile, and/or store one or more data points and/or presentations relating to one or more near field gaming options and/or near field gaming functions.

Far field module 412 may generate, transmit, compile, and/or store one or more data points and/or presentations relating to one or more far field gaming options and/or far field gaming functions.

Influence module 414 may generate, transmit, compile, and/or store one or more data points relating to one or more voting procedures, voting structures, projects, influence criteria, and/or any other voting data. For example, males in a first age group with a first set of characteristics (e.g., income, profession, education, etc.) accounted for 25% of the approval votes for a first project while only 1% of the approval votes for the first project where from males in a second group with a second set of characteristics. In another example, males in a second age group purchased a first product on Mondays and Fridays 80% of the time.

Funding module 416 may generate, transmit, compile, and/or store one or more data points relating to one or more funding procedures, funding structures, projects, and/or any other funding data. For example, females in a third age group with a third set of characteristics (e.g., income, profession, education, etc.) accounted for 50% of the funding amount for a third project while only 5% of the funding amount for the third project where from females in a fourth group with a fourth set of characteristics. In another example, females in a second age group purchased a first product on Tuesdays and Wednesdays 80% of the time.

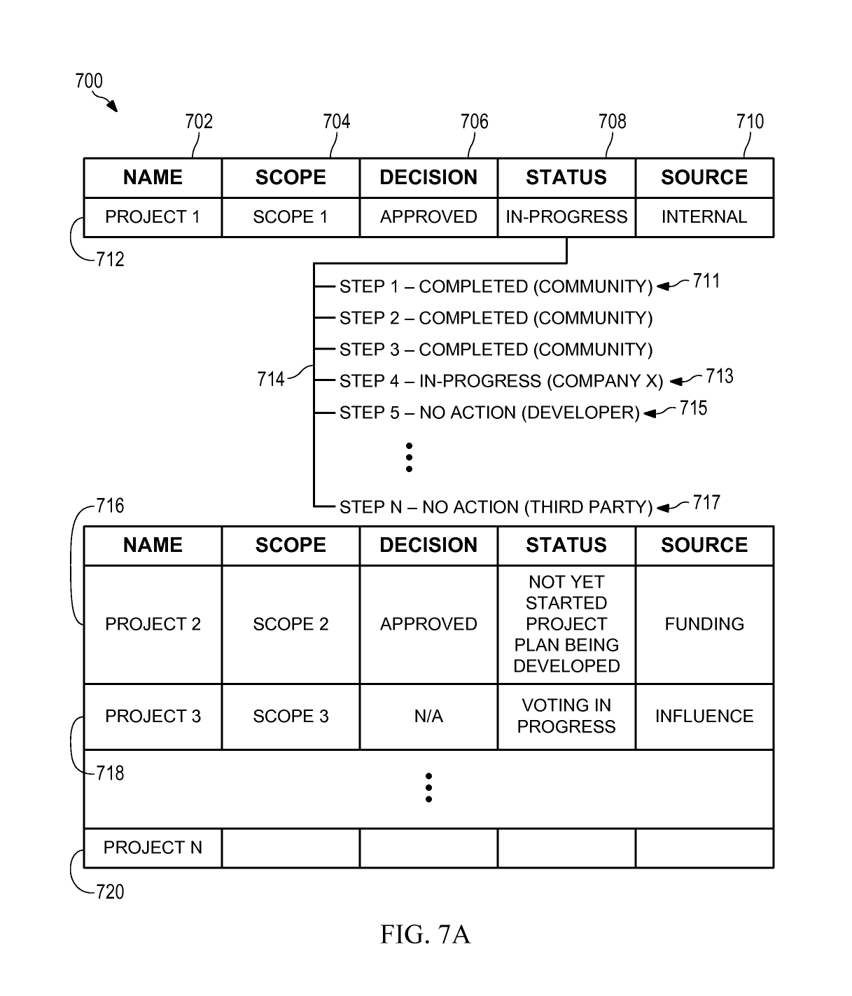

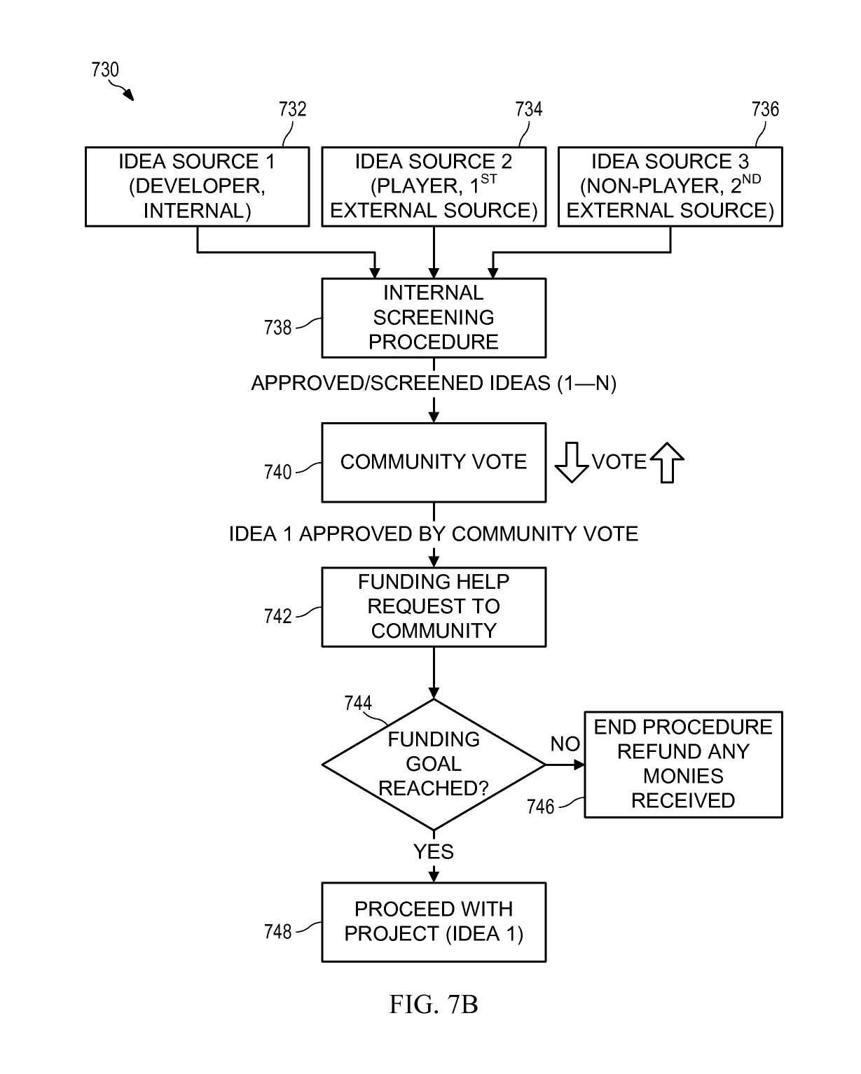

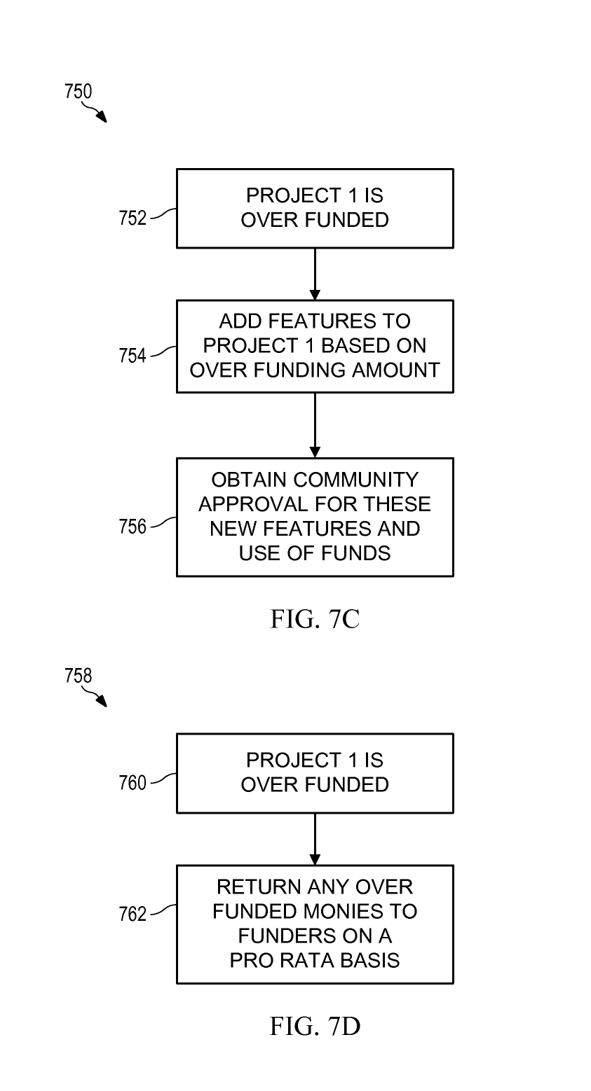

Roadmap module 418 may generate, transmit, compile, and/or store one or more data points relating to one or more roadmap procedures, roadmap structures, projects, and/or any other roadmap data. For example, a first roadmap for a first project may include any number of steps and/or action items (e.g., 1 to N) for completion of the first project (See FIG. 7A, reference numbers 711, 713, 714, 715, and 717).

Presentation module 422 may generate, transmit, compile, implement, and/or store one or more presentations relating to game play, usage, purchases, advertisements, voting procedures, funding procedures, and/or any other items in this disclosure.

Implementation module 424 may generate, transmit, compile, implement, and/or store one or more presentations relating to game play, usage, purchases, advertisements, voting procedures, funding procedures, and/or any other items in this disclosure.

Tracking module may generate, transmit, compile, and/or store one or more data points related to tracking one or more player/user activities. For example, a first player may have voted for projects 1, 5, 12, and 20 while funding projects 1 and 20 which may be compiled, stored, and analyzed to generate one or more reports and/or one or more algorithms which can be utilized for future use. In one example, the system, device, and/or method may determine why the player/user funded projects 1 and 20 but did not fund either project 5 and/or 12.

Signage module may generate, transmit, compile, initiate, and/or store one or more presentations for one or more signs and/or one or more displays.

Advertisement module 426 may generate, transmit, compile, present, implement, initiate, and/or store one or more advertisements. Advertisement module 426 may generate, compile, transmit, and/or store advertisement information relating to one or more game play.

Near field evaluation module may evaluate one or more outcomes for one or more events relating to near field game play. Further, near field evaluation module may determine one or more outcomes of one or more interactions.

3D gesturing module 428 may generate, compile, transmit, and/or store one or more data points, presentations, reference modules, and/or structure relating to any aspect of 3D gesturing.

Skill-based module 430 may generate, compile, store, and/or transmit one or more skill-based structures and/or one or more skill-based structures. Skill-based evaluation module may evaluation one or more outcomes of one or more skill-based games and/or skill-based extra game play.

Strategic-based game play module 432 may generate, compile, store, and/or transmit one or more strategic-based structures and/or one or more strategic-based structures. Strategic-based evaluation module may evaluation one or more outcomes of one or more strategic-based games.

Game play module 434 may generate, compile, store, and/or transmit one or more gaming structures. Gaming evaluation module may evaluation one or more outcomes of one or more games.

Mobile device module may generate, compile, store, and/or transmit one or more data relating to the mobile device. Further, mobile device module may interact and communicate with mobile device to transfer and/or receive data from and/or to mobile device.

Game configuration module may generate, compile, store, and/or transmit one or more game configuration data. Further, mobile device may also include a game configuration module. For example, a first player may be playing a first game on a console and be at a first position in the first game. The first game may be configured per the first player's preferences. The first player may transfer the first game play from the console to a mobile device where the player may continue at the first position and the game play may include the first player's preferences utilized on the console.

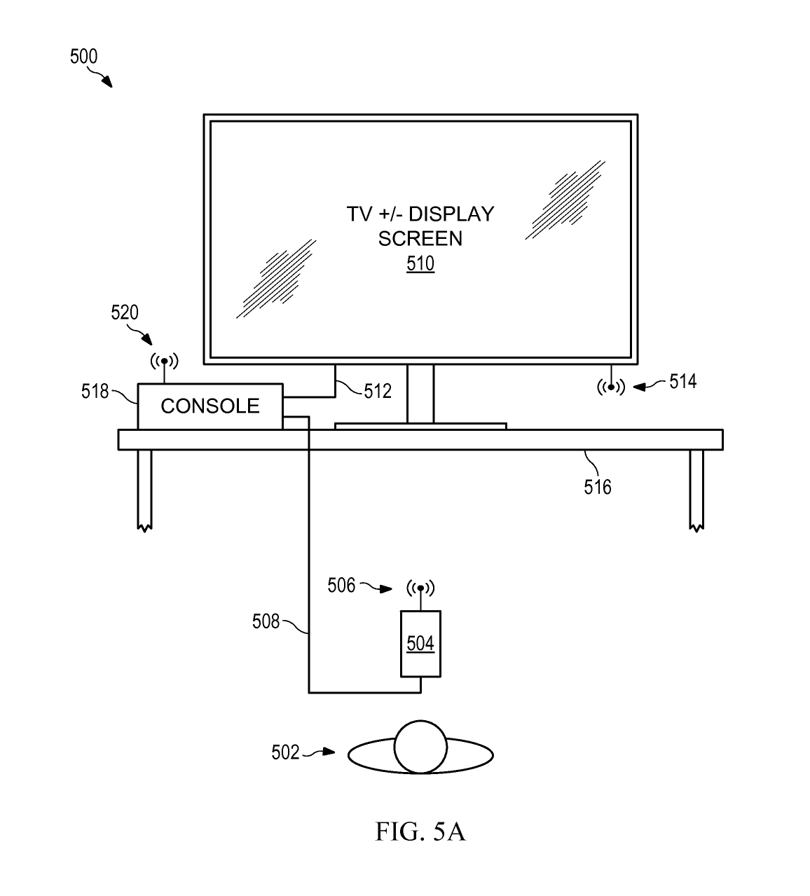

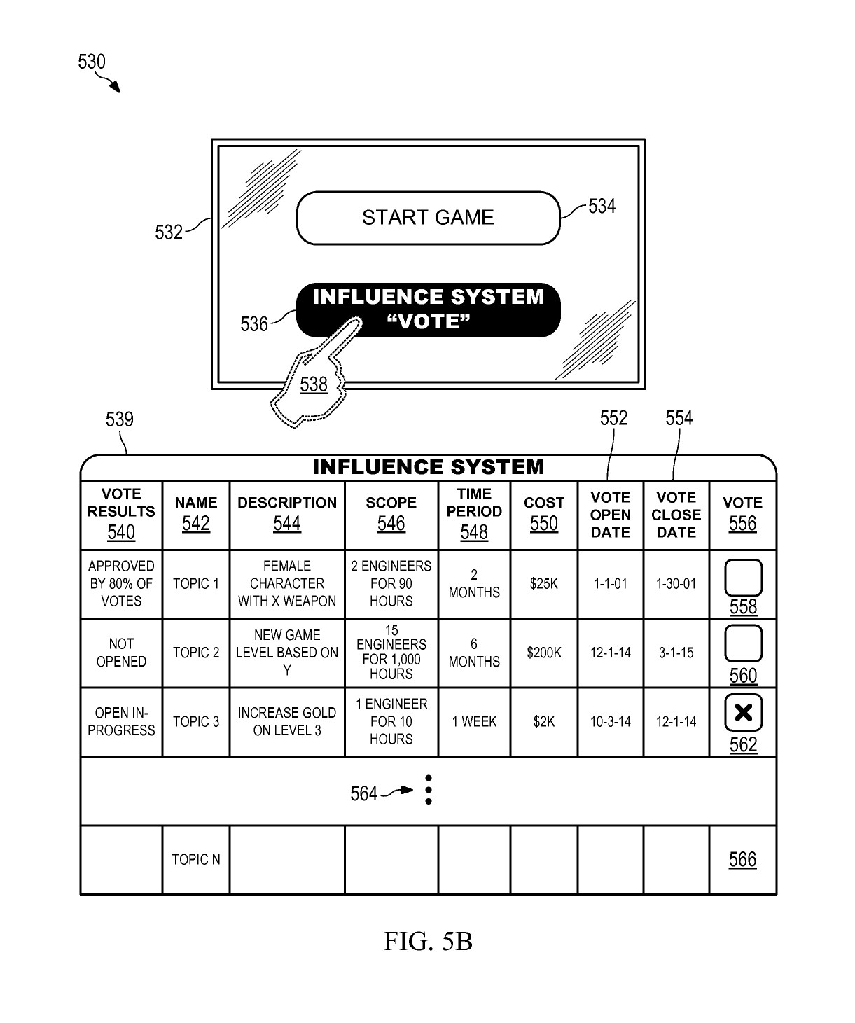

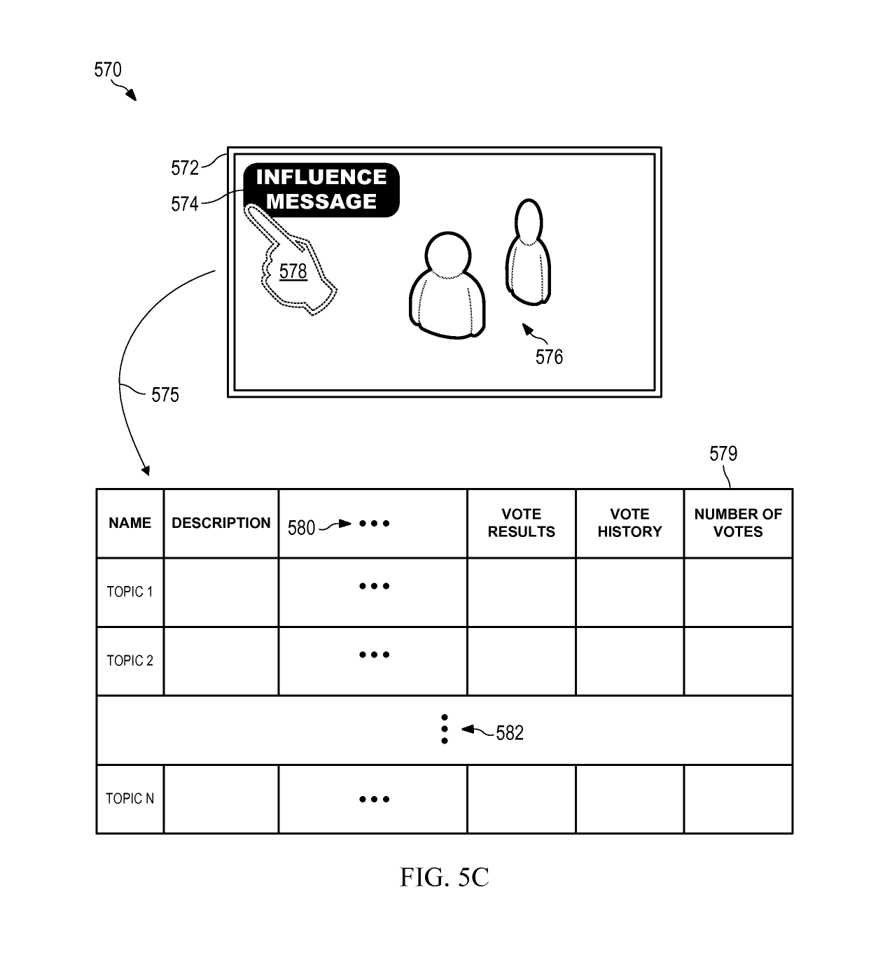

In FIG. 5A, an illustration of game play on a gaming device is shown, according to one embodiment. A first image 500 may include a player 502 sitting in a chair utilizing a controller 504 to send/receive signals 506 to/from a console 518 located on a table 516. Console 518 may communicate wired 512 and/or wirelessly 520 with a display device 510 (e.g., any number of display devices—1 to N). In various examples, the player 502 may be initiating a purchase, playing a game, communicating with other players, voting for a project, and/or funding a project.

In FIG. 5B, an illustration of influence procedure for a product is shown, according to one embodiment. A second image 530 may include a display 532 which includes a start game button 534 and an influence system voting button 536. The player may select (reference number 538) the influence system voting button 536 which initiates an influence screen 539. The influence screen 539 may include a vote results area 540, a name area 542, a description area 544, a scope area 546, a time-period area 548, a cost area 550, a vote open date area 552, a vote close date area 554, and a vote area 556. In one example, a topic 1 row 558, a topic 2 row 560, a topic 3 row 562, and/or a topic N row 564. In one example, topic 1 row 558 may be related to one or more characteristics of a female character. In this example, the project related to topic 1 has been approved by 80% of the votes, will require 2 engineers for 90 hours to complete the project, take 2 months to complete, cost $25K, and the voting was opened on Jan. 1, 2001 and closed on Jan. 30, 2001.

In another example, a topic 2 row 560 may be related to one or more characteristics for a new game level based on Y. In this example, the project related to topic 2 has no approval votes because it has not been opened up for voting yet, will require 15 engineers for 1,000 hours to complete the project, will take 6 months to complete, will cost $200K, and the voting will open up on Dec. 1, 2014 and the voting will close on Mar. 1, 2015.

In another example, a topic 3 row 562 may be related to one or more characteristics for increasing a gold amount on level 3. In this example, the project relating to topic 3 has no approval votes but has been opened up for voting, will require 1 engineer for 10 hours to complete the project, will take 1 week to complete, will cost $2K, and the voting opened up on Oct. 3, 2014 and the voting will close on Dec. 1, 2014.

In another example, a topic N row 564 may relate to any gaming characteristic, a new game, a new product, a new service, and/or any combination thereof.

In FIG. 5C, an illustration of influence procedure for a product is shown, according to one embodiment. In this example, an influence message area 574 is shown while the player is interacting 576 with the game on display screen 572. If the player selects (reference number 578) the influence message area 574, then an influence screen 579 is display (reference number 575) and game play may be halted and/or paused. In one example, a player may be playing a first game and an influence message is shown on a portion of the screen. The player may indicate that the player wants to read the influence message which halts and/or pauses the first game while the player is taken to an influence message screen (see reference numbers 575 and 579). In various examples, the person may have been making an online purchase (and/or watching a video, and/or voting, and/or funding, and/or utilizing a service, and/or any other activity) when the influence message appear and the purchase may be halted and/or paused.

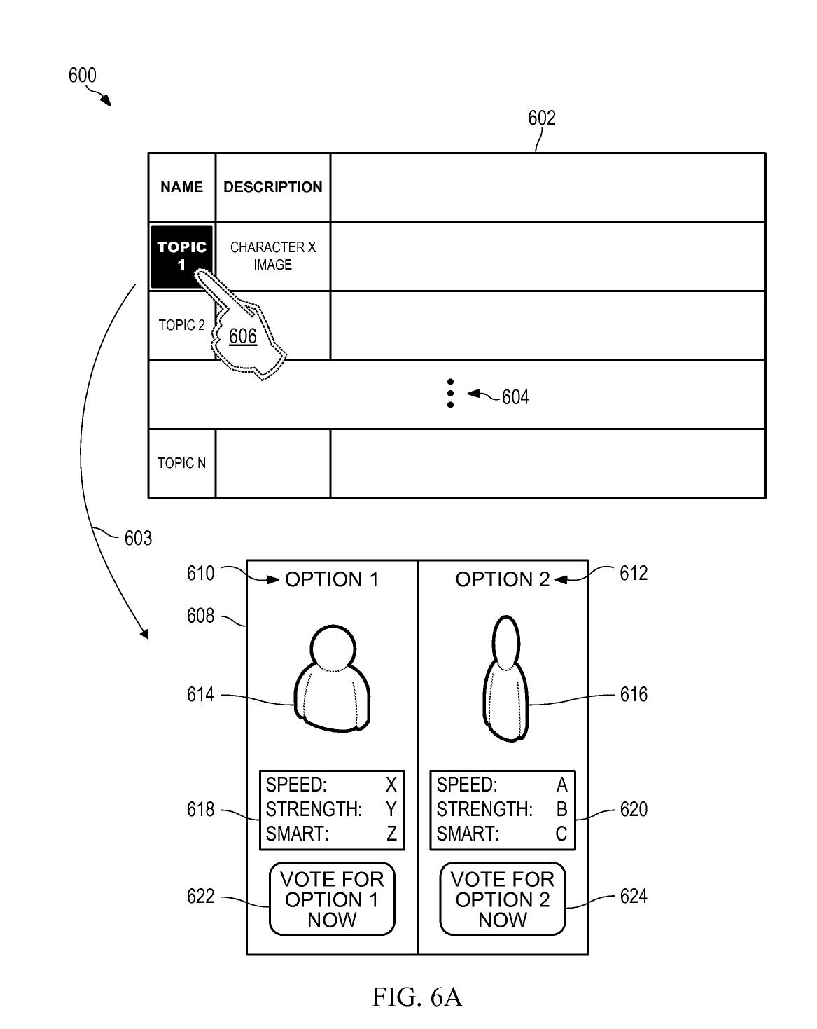

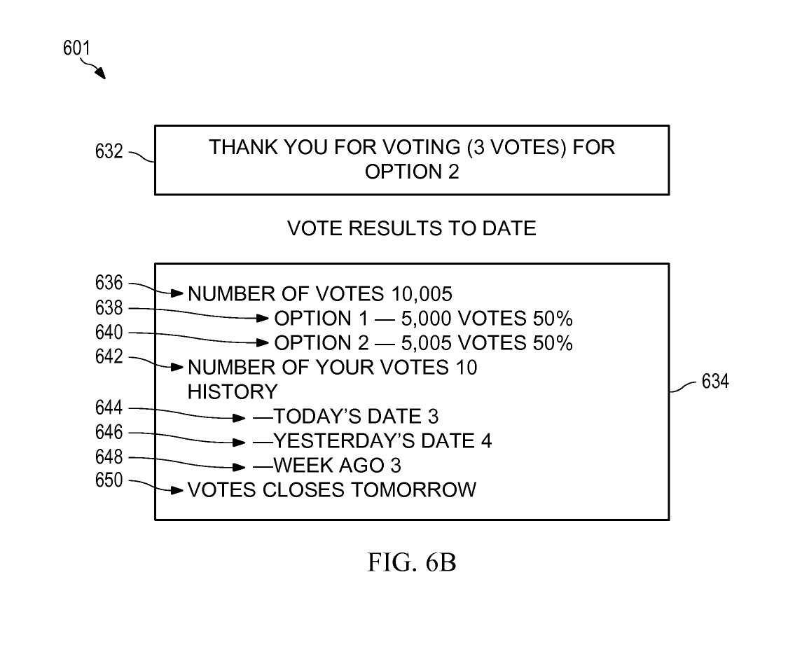

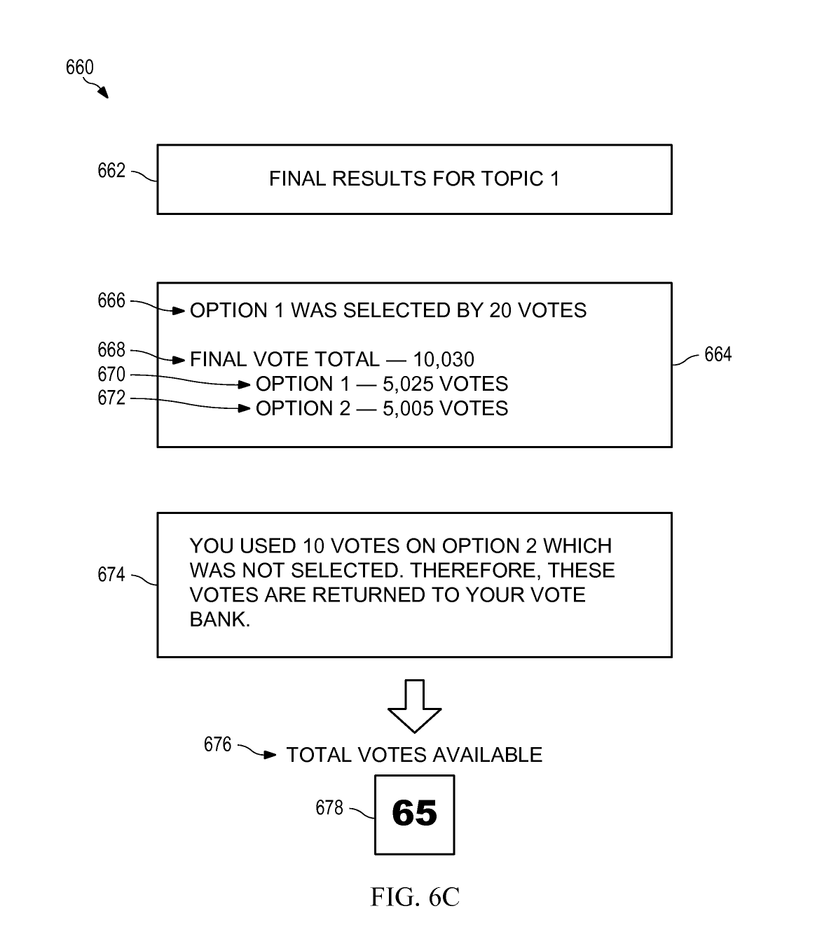

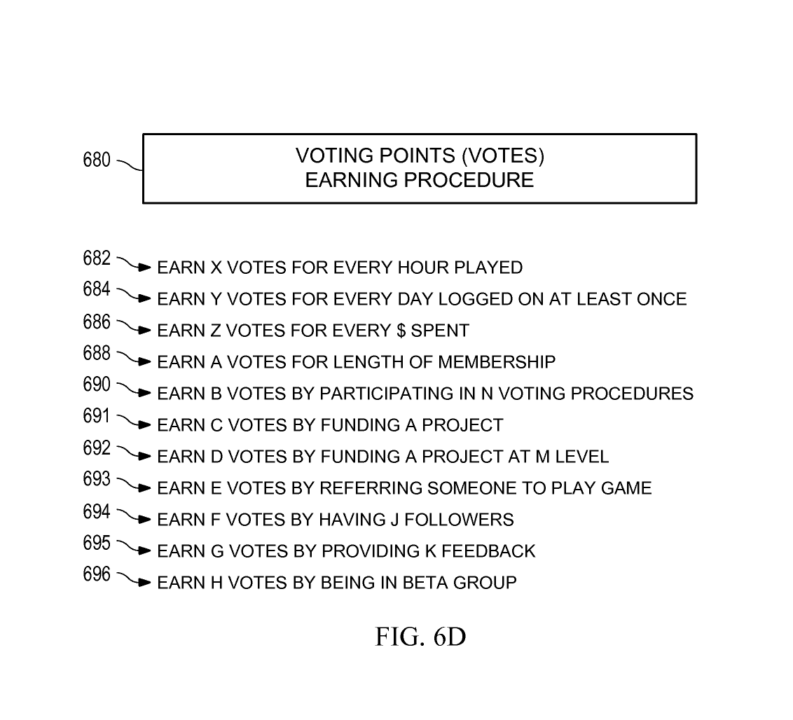

In FIG. 6A, another illustration of influence procedure for a product is shown, according to one embodiment. A third image 600 may include an influence table 602 which include one or more selection areas. In this example, the first topic was selected 606 which displayed a first voting idea 608. In this example, first voting idea 608 has two options (e.g., option 1 (reference number 610) and option 2 (reference number 612)). However, any number of options (e.g., 1 to N) could be utilized. In this example, a first option 610 includes a first character option 614 with a first character characteristics 618. The player may vote for first option 610 by selecting first voting button 622. Further, a second option 612 may include a first character option 616 with a second character characteristics 620. In one example, the first character characteristics 618 may include a speed of X (e.g., a first speed level), a strength of Y (e.g., a first strength level), a smart of Z (e.g., a first smart level), etc. In one example, the second character characteristics 620 may include a speed of A (e.g., a second speed level), a strength of B (e.g., a second strength level), a smart of C (e.g., a second smart level), etc. In another example, the characteristics may relate to any attribute (e.g., healing power, height, weight, color, shape, etc.) of any character. Further, the characteristics may relate to any attribute (e.g., speed, cost, quality, reliability, responsiveness, etc.) of any service (e.g., delivery, professional service, etc.). In addition, the characteristics may relate to any attribute (e.g., size, color, cost, etc.) of any product (e.g., watch, car, refrigerator, etc.).

In FIG. 6B, another illustration of an influence procedure for a product is shown, according to one embodiment. In one example, the system may display (after a person has voted) an image 601 which includes a first message 632 which may state “thank you for voting (3 votes) for option 2”. In this example, the player has utilized 3 votes from the player's vote balance. In various examples, the player may utilize one, a few, a plurality, and/or all of their votes on any voting procedure (e.g., project 1, project 2, etc.). In various examples, the votes and/or voting procedure may be limited and/or capped, the limiting and/or capping may be based on time, based on game play, based on previous voting history, based on purchases, based on usage, based on funding history, and/or any other factor. Further, the system may display the vote results to date. A second message 634 may include a number of votes 636 received which in this example is 10,005. The second message 634 may further state a number of votes for a first option 638 which in this example is 5,000 votes (50%). The second message 634 may further state a number of votes for a second option 640 (up to an Nth option) which in this example is 5,005 votes (50% —any percentages may be displayed based on the number of votes compared to the number of total votes). The second message 634 may further state a number of total player votes 642 for this voting procedure which in this case may be 10 (may be 0 to N). Further, the voting history for the player may be shown which in this example is that the player utilized 3 votes today (e.g., a first time) on this option, 4 votes yesterday (e.g., a second time), and 3 votes a week ago (e.g., an Nth time). In addition, the second message 634 may state a vote closing time 650 (e.g., vote closes tomorrow and/or any other time period). In another example, a project may have 49% approved and 51% non-approval votes. In this example and/or any other example in this disclosure, the project may be approved and funded by the company (instead of the community) because the community did not have enough approval votes. Further, the project may be funded by the community even though the project did not receive enough of the popular vote because an important part of the community wanted the project to proceed.

In FIG. 6C, another illustration of an influence procedure for a product is shown, according to one embodiment. In one example, a fourth image 660 may include a final results area 662 which states final results for topic 1. Further, fourth image 660 may include a summary of the results area 664 which states option 1 was selected by 20 votes 666. Further, a final vote total 668 of 10,030 votes may be shown with a first option total votes 670 of 5,025 votes and a second option total votes 672 of 5,005. In addition, a return vote's message 674 may state you used 10 votes on option 2 which was not selected. Therefore, these votes are returned to your vote bank. Any votes utilized for a non-winning option may be returned to the player. In another example, these votes may not be returned. In a further example, these votes may be returned on a prorated basis. Further, a total player vote's available message 676 may be shown along with a total vote's number area 678 (e.g., 65 votes and/or any other number (e.g., 0-N)). In one example, a player may utilize 10 votes on option 2 which was not selected and because the system, device, and/or method is designed to not return any used votes, the player does not receive any of the 10 votes back. In another example, a player may utilize 10 votes on option 2 which was not selected and because the system, device, and/or method is designed to only return a portion of any used votes, the player receives a percentage (and/or portion) of the 10 votes back (e.g., 5%, 10% . . . 50%, 52%, . . . 83%, 95%, etc.).

In FIG. 6D, another illustration of an influence procedure for a product is shown, according to one embodiment. In one example, a voting earning procedure menu screen 680 is shown. In one example, a first method of earning votes 682 may include earning X votes for every hour played. In one example, a second method of earning votes 684 may include earning Y votes for every day logged on at least once. In one example, a third method of earning votes 686 may include earning Z votes for every $ spent. In one example, a fourth method of earning votes 688 may include earning A votes for the length of membership time. In one example, a fifth method of earning votes 690 may include earning B votes by participating in X voting procedures. In one example, a sixth method of earning votes 691 may include earning C votes by funding a project. In one example, a seventh method of earning votes 692 may include earning D votes by funding a project at an M level. In one example, an eighth method of earning votes 693 may include earning E votes for referring someone to play the game. In one example, a ninth method of earning votes 694 may include earning F votes by having J followers. In one example, a tenth method of earning votes 695 may include earning G votes by providing K feedback submissions. In one example, an eleventh method of earning votes 696 may include earning H votes by being in a Beta group. These methods of earning votes may be combined.

In one example, a first method of earning votes 682 may include earning X votes for every hour played—in this example, a player may earn (e.g., 0.5, 1, 1.5, 1.75, . . . 100 . . . any number) of votes for each specific (and/or predetermined) time period (e.g., 1 minute, 5 minutes, 30 minutes, 1 hour, 5 hours, 1 day, 1 week, 1 month, etc.) of play. In another example, a second method of earning votes 684 may include earning Y votes for every day logged on at least once—in this example, a player may earn (e.g., 0.5, 1, 1.5, 1.75, 5, 10, . . . 100 . . . any number) of votes for a specific (and/or predetermined) number (e.g., 2, 3, 4, . . . , any number, etc.) of consecutive days of logging on. In one example, a third method of earning votes 686 may include earning Z votes for every $ spent—in this example, a person may earn (e.g., 1, 2, 3, 4, 5, . . . any number) of votes for each and/or a predetermined number of dollars spent on purchases. In one example, a fourth method of earning votes 688 may include earning A votes for a length of membership time—in this example, a person may earn votes based on the length of membership (e.g., 1 month, . . . 6 months, . . . , 1 year, etc.). In one example, a fifth method of earning votes 690 may include earning B votes by participating in X voting procedures—in this example, a person may receive a first level of votes (e.g., 1) for participating in a first level of voting procedures (e.g., 5) and then the person may receive a second level of votes (e.g., 5) for participating in a second level of voting procedures (e.g., 15). There may be any number of levels (e.g., 1 to N) and any level of votes granted (e.g., 1 to N) and any level of voting procedure levels (e.g., 1 to N). This structure may be used with any example disclosed in this disclosure.

In one example, a sixth method of earning votes 691 may include earning C votes by funding a project—in this example, a person may receive a first level of votes (e.g., 5) for participating in a first level of funding procedures (e.g., 1) and then the person may receive a second level of votes (e.g., 20) for participating in a second level of funding procedures (e.g., 3). There may be any number of levels (e.g., 1 to N) and any level of votes granted (e.g., 1 to N) and any level of funding procedure levels (e.g., 1 to N). In one example, a seventh method of earning votes 692 may include earning D votes by funding a project at an M level—in this example, a person may receive a first level of votes (e.g., 6) for participating in at a first level of funding (e.g., $500.00) and then the person may receive a second level of votes (e.g., 25) for participating in at a second level of funding (e.g., $1,500.00). There may be any number of levels (e.g., 1 to N) and any level of votes granted (e.g., 1 to N) and any level of funding levels (e.g., 1 to N). In one example, an eighth method of earning votes 693 may include earning E votes for referring someone to play the game—in this example, a person may receive a first level of votes (e.g., 1) for referring other people at a first level of referrals (e.g., 1) and then the person may receive a second level of votes (e.g., 10) for referring other people at a second level of referrals (e.g., 8). There may be any number of levels (e.g., 1 to N) and any level of votes granted (e.g., 1 to N) and any level of referral levels (e.g., 1 to N). In one example, a ninth method of earning votes 694 may include earning F votes by having J followers—in this example, a person may receive a first level of votes (e.g., 5) for having followers at a first level (e.g., 10) and then the person may receive a second level of votes (e.g., 50) for having followers at a second level (e.g., 50). There may be any number of levels (e.g., 1 to N) and any level of votes granted (e.g., 1 to N) and any level of follower levels (e.g., 1 to N). In one example, a tenth method of earning votes 695 may include earning G votes by providing K feedback submissions—in this example, a person may receive a first level of votes (e.g., 1) for a first level of submissions (e.g., 5) and then the person may receive a second level of votes (e.g., 4) for a second level of submissions (e.g., 15). There may be any number of levels (e.g., 1 to N) and any level of votes granted (e.g., 1 to N) and any level of submission levels (e.g., 1 to N). In one example, an eleventh method of earning votes 696 may include earning H votes by being in a Beta group.

In FIG. 7A, another illustration of an influence procedure for a product is shown, according to one embodiment. In this example, a roadmap image 700 may include a name area 702, a scope area 704, a decision area 706, a status area 708, and a source area 710. Further, a first project 712 may include a project 1 title in name area 702, a first scope description in scope area 704, a decision message in decision area 706, a status message (e.g., the project is being worked on, denied, cancelled, approved, pending, finished, started, will start on X date, on hold, etc.) in status area 708, and a source message (e.g., submitted by internal sources, external source, player, vendor, third party, etc.) in source area 710. Further, a sub-project steps 714 may include all of the steps with a status for each (e.g., completed, in-progress, no action, denied, cancelled, approved, pending, finished, started, will start on X date, on hold, needs additional funding, etc.). In one example, the entity funding a specific piece of the project will be noted. For example, reference number 711 shows that the community funded step 1 (also steps 2 and 3), reference number 713 shows that the company funded step 4, reference number 715 shows that the developer funded step 5, and reference number 717 shows that a third party funded step N.

Further, a second project 716 may have been approved but may have a status of not yet started because the project plan is being developed —this project may have been funded by the community. In addition, a third project 718 may have a no decision status because the third project 718 is still in the voting process and may have been submitted by an influence person. Further, up to an Nth project 720 may be displayed with corresponding data. Projects may be submitted by internal sources, external sources, players, vendors, and/or third parties. Further, ideas submitted by these entities may be combined. In one example, a first submission by an internal source relates to creating a first player with various characteristics and a second submission by an external source relates to creating a second player with various characteristics. In one example, these two submissions may be combined to form a first project.

In FIG. 7B, another illustration of an influence procedure for a product is shown, according to one embodiment. In this example, there may be Nth number of sources for project ideas. For example, three sources which include a first source 732 (e.g., idea source 1—developers, internal sources), a second source 734 (e.g., idea source 2—players, first external source), and an Nth source 736 (e.g., idea source N—non-player, second external source). Once an idea is submitted, an internal screen procedure 738 is initiated—this procedure validates the idea and develops a cost/benefit analysis. Further, the approved/screened ideas (e.g., 1 to N) may be submitted to the community for a vote. In the community vote 740, the community (e.g., players, etc.) may give an up or down vote.

In this example, a first idea was approved by the community vote. In one example, a funding help request to community 742 may be initiated. In another example, the system, device, and/or method may determine whether the funding goal has been reached 744. If the funding goal has not been reached, then the system, device, and/or method may end and any fund may be returned to one or more sources (e.g., player, etc.) 746. In another example, if the funding goal has been reached, then the system, device, and/or method may proceed with the project (e.g., idea 1) 748.

Please note that these ideas submitted by these entities may be combined. In one example, a first submission by an internal source relates to creating a first player with various characteristics and a second submission by an external source relates to creating a second player with various characteristics. In one example, these two submissions may be combined to form a first project.

In FIG. 7C, another illustration of an influence procedure for a product is shown, according to one embodiment. In this example, the system, device, and/or method may determine whether project 1 has been overfunded (e.g., step 752). If project 1 has been overfunded, then the system, device, and/or method may add features to project 1 based on the overfunding amount (step 754). Further, the new features for project 1 may be submitted to the community to obtain community approval for these new features and/or any other use of funds (step 756). In one example, an approved project for a new product had a funded budget of $100,000. The approved project for the new product had 10 items that needed to be completed to create the new product. However, the completion of the new product only required $70,000. Therefore, features 11-15 were added to the new product at a cost of $30,000 and the new product may be released with 15 items, instead of the original 10 items approved. Further, these additional features and/or items (11-15) may be submitted to the community of funders (only the individuals that funded the project not the entire community) to obtain their approval before these new features and/or items are implemented. In addition, any number of new features may be submitted to the community and the community is allowed to select and/or vote on and/or fund the additional features. For example, 10 items may be submitted to the community where all 10 items cost $6,000 to implement and then the community may vote for their top 5 choices to be added to the new product to utilize the $30,000 in additional funds (e.g., 5 items times $6,000 per item equals $30,000—added to the $70,000 already spent equals the total funded budget of $100,000). In another example, 10 items may be submitted to the funders (only the individuals that funded the project not the entire community) where all 10 items cost $6,000 to implement and then the funders (only the individuals that funded the project not the entire community) may vote for their top 5 choices to be added to the new product to utilize the $30,000 in additional funds (e.g., 5 items times $6,000 per item equals $30,000—added to the $70,000 already spent equals the total funded budget of $100,000).

In FIG. 7D, another illustration of an influence procedure for a product is shown, according to one embodiment. In one example, when a project is overfunded, the method may determine whether the project is overfunded (step 760). The method may return any overfunded monies to funders (e.g., people who paid to fund project 1) on a pro rata basis (step 762). In one example, an approved project for a new product had a funded budget of $100,000. The approved project for the new product had 10 items that needed to be completed to create the new product. However, the completion of the new product only required $70,000. The $30,000 surplus may be distributed back to the funders. In one example, there were 100 funders so each funder would receive $300 back.

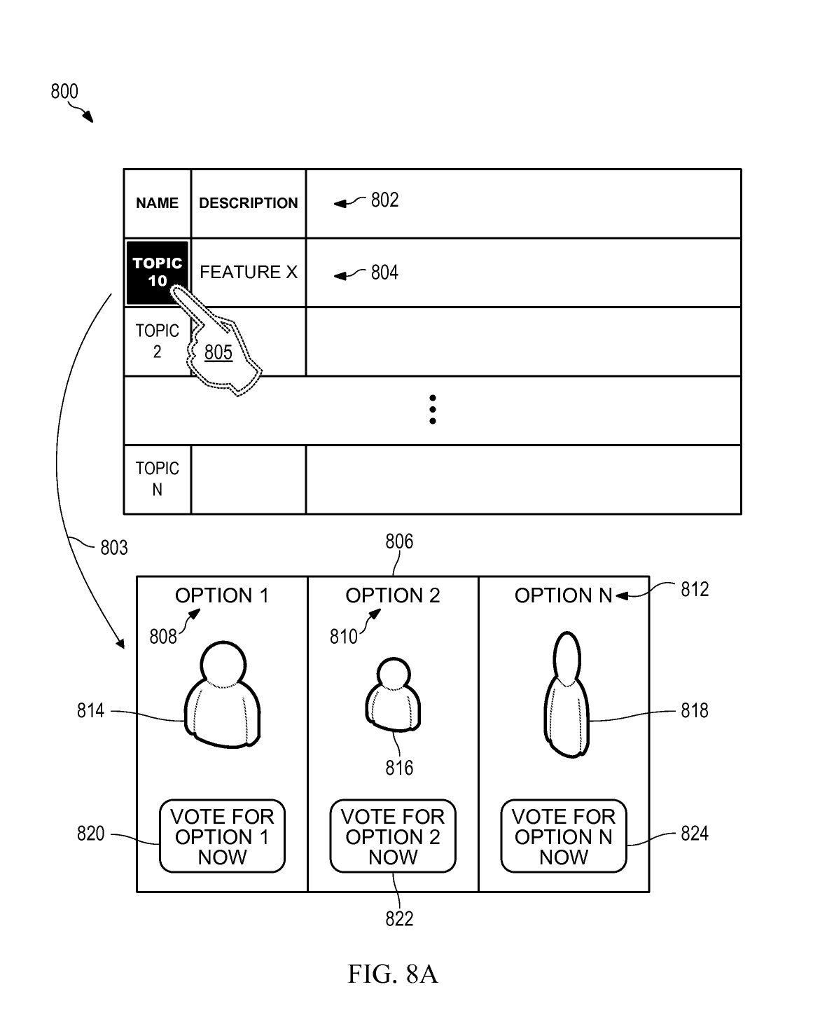

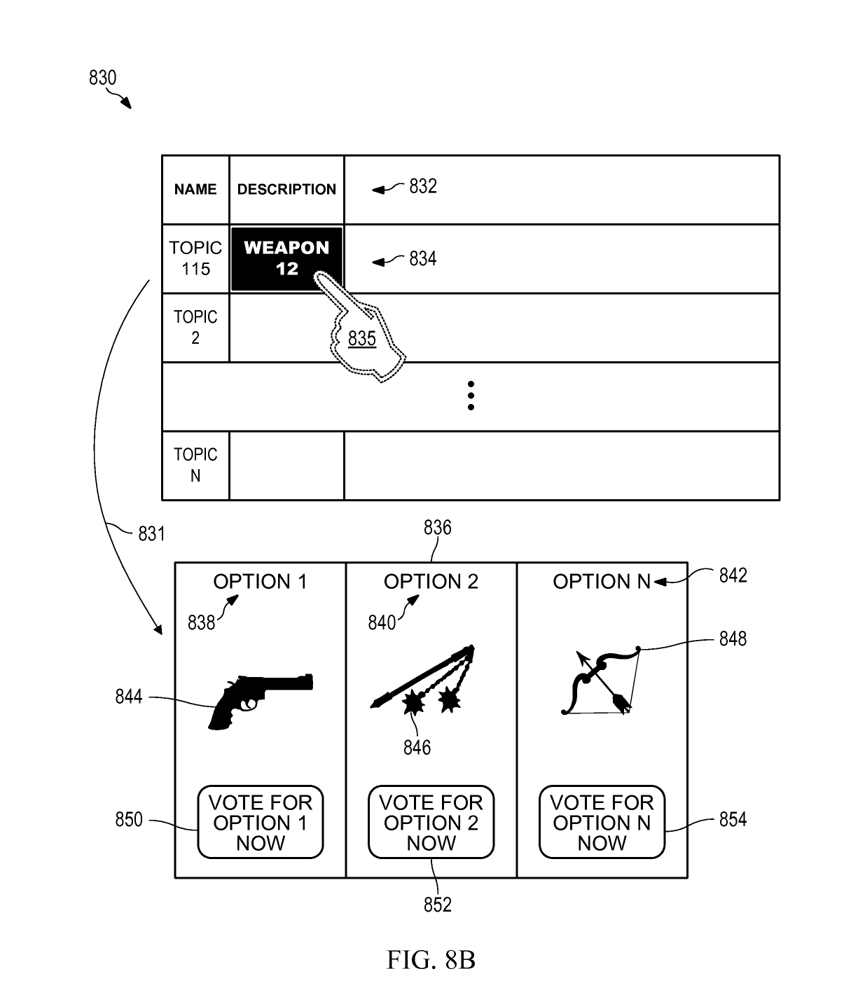

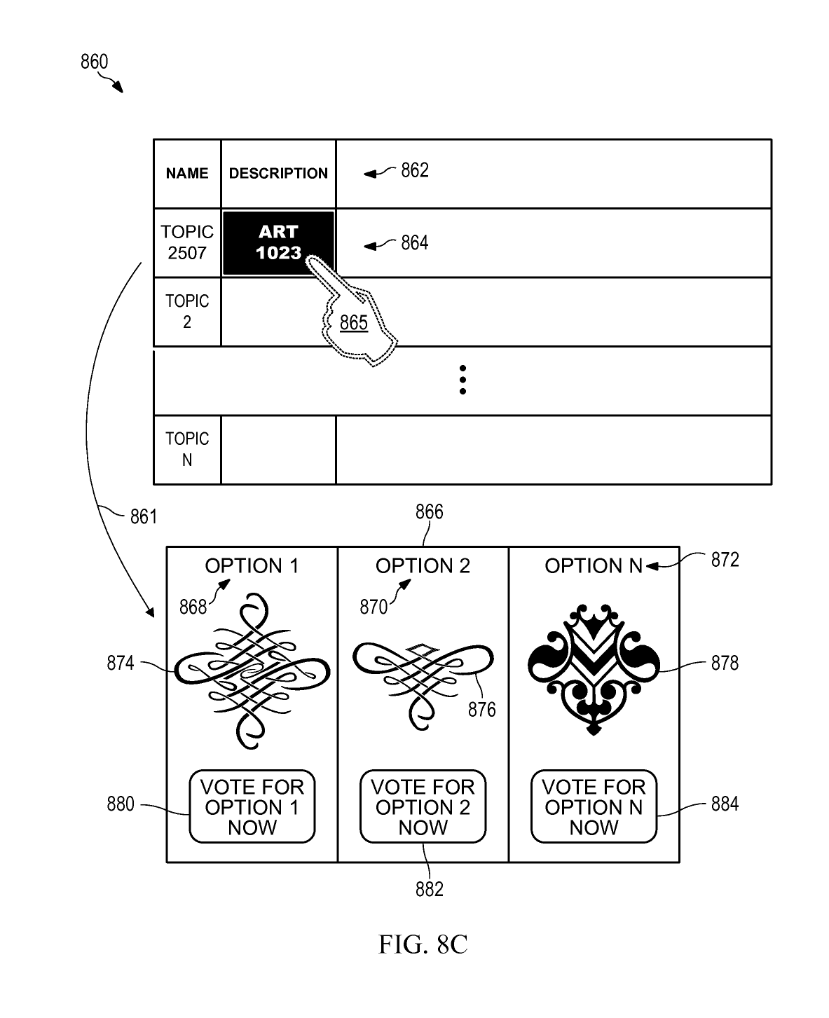

In FIG. 8A, another illustration of an influence procedure for a product is shown, according to one embodiment. A fifth image 800 may include a project list box 802 and a first project details 804. After selecting (reference numbers 803 and 805) the first project, a first project options screen 806 is shown. First project options screen 806 may include a first option 808, a second option 810, and an Nth option 812. First option 808 may include a first player icon 814 with four arms and two legs. Second option 810 may include a second player icon 816 with two arms and four legs. Nth option 812 may include an Nth player icon 818 with four arms, four sub-arms, and four legs. Further, a first voting button 820 may be utilized to select the first option. In addition, a second voting button 822 may be utilized to select the second option. Lastly, a third voting button 824 may be utilized to select the Nth option.

In FIG. 8B, another illustration of an influence procedure for a product is shown, according to one embodiment. A sixth image 830 may include a project list box 832 and a second project details 834. After selecting (reference numbers 831 and 835) the second project, a second project options screen 836 is shown. Second project options screen 836 may include a first weapon option 838, a second weapon option 840, and an Nth weapon option 842. First weapon option 838 may include a first weapon icon 844 which is a gun. Second weapon option 840 may include a second weapon icon 846 which is a flail. Nth weapon option 842 may include an Nth weapon icon 848 which is a bow. Further, a first voting button 850 may be utilized to select the first option. In addition, a second voting button 852 may be utilized to select the second option. Lastly, a third voting button 854 may be utilized to select the Nth option.

In FIG. 8C, another illustration of an influence procedure for a product is shown, according to one embodiment. A seventh image 860 may include a project list box 862 and a third project details 864. After selecting (reference numbers 861 and 865) the third project, a third project options screen 866 is shown. Third project options screen 866 may include a first art option 868, a second art option 870, and an Nth art option 872. First art option 868 may include a first art icon 874 which is a first artwork (e.g., star-based art work). Second art option 870 may include a second art icon 876 which is a second artwork (e.g., water-based art work). Nth art option 872 may include an Nth art icon 878 which is a third artwork (e.g., mountain-based art work). Further, a first voting button 880 may be utilized to select the first option. In addition, a second voting button 882 may be utilized to select the second option. Lastly, a third voting button 884 may be utilized to select the Nth option.

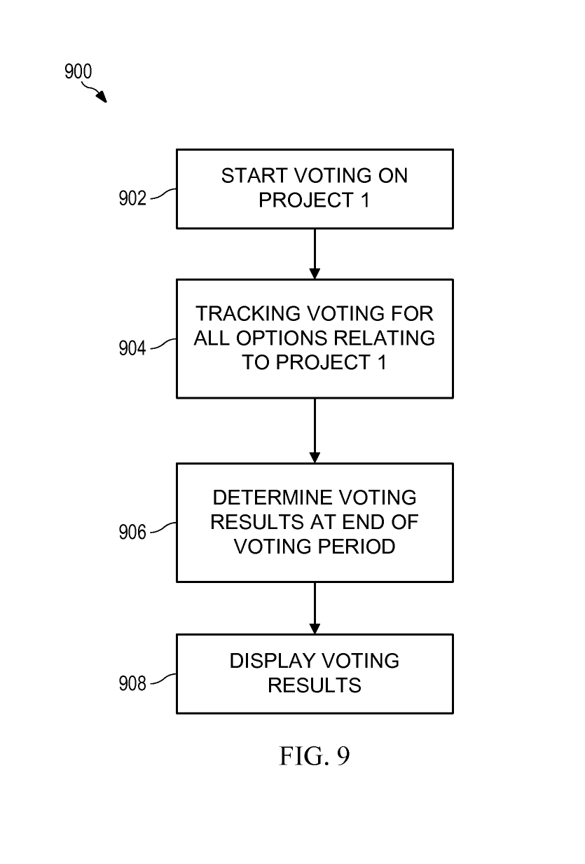

In FIG. 9, a flow diagram is shown, according to one embodiment. The method may include starting a voting procedure for a first project (step 902). The method may include tracking voting for all options (and/or a portion and/or subset) relating to a first project (step 904). The method may include determining the voting results at the end of a voting period (step 906). The method may include displaying the voting results (step 908). In one example, a voting procedure for a first project may start at a first time and the voting procedure for the first project may end at a second time. During the time period between the first time and the second time, voting data may be collected and compiled by the system, device, and/or method. In one example, a current voting total may be displayed (e.g., 504 votes for and 323 votes against the first project). In another example, the first project may be broken down into a plurality of subparts (e.g., first project part 1, first project part 2, first project part 3, . . . , first project part N). These subparts of first project may also be voted on. For example, first project part 1 has 300 votes approving it and 150 votes denying it while first project part 2 has 10 votes approving it and 440 votes denying it. In one example, a party needs to vote for every subpart during the voting process. In another example, a party may vote for one or more subparts but does not need to vote (either for or against) for every subpart.

In one example, influence system, device, and/or method may be an online platform that allows players to use time spent using and/or purchasing software/games/devise/services to vote on how the software/games/devise/services is developed and to suggest and fund individual features of the software/games/devise/services that will be developed in the future. In other examples, a system can be binary which is not a dynamic system. A binary system (which the influence system, device, and/or method are not) does not allow consumers to use time spent playing/using/purchasing a game/device/product/server to quantify how much influence they have. The influence system, device, and/or method gives users the ability to influence the software/games/devise/services based on how much they've played/used/bought it allows for more accurate decision making among the community of players/users/purchasers.

In one example, players/consumers/users are given a description of a software/games/devise/services and must choose whether to fund it based on that description. The influence system, device, and/or method allows consumers/users/purchasers/players to suggest their own ideas for the software/games/devise/services, collaborate with other consumers and developers to design a specific feature from that idea, and then crowd source the funding for that specific feature to be incorporated into the software/games/devise/services. It is an entirely new way of monetizing software/system/devices/products/services, whereby the consumer/user/purchaser is both sourcing the ideas and funding for individual features of a product/device/game/service.

In one example, the process is split into two parts: Influencing and Funding. In this example, influencing is the act that a consumer/player/user/purchaser does to influence the creation and/or direction of the product/device/game/service. In one example, time spent using and/or purchasing the software/product/device/game/service is converted by an algorithm to a set amount of influence points. These influence points can be spent on answering questions in the influence portal and/or voting in one or more voting procedures. Each of these questions may be multiple choice question that help determine the direction of future development of the software/product/device/game/service. In one example, consumer/player/user/purchaser can put any number of points into one of the question's choices. Each question may have a time limit, after which voting and/or point allocation is no longer allowed and a decision is reached. When a question reaches its time limit, the total number of points for each choice is tallied and a winner is chosen. In one example, points that were put into the losing choices may be reimbursed back to the consumer for use in future votes and/or questions.

In one example, funding is the act that a consumer/player/user/purchaser does to fund a new software/product/device/game/service and/or a new feature for the software/product/device/game/service. Consumers, a member of the development team, players, third parties, vendors, and/or any other source may use an application form and/or a procedure to submit ideas for the software/product/device/game/service to one or more communities and/or one or more developers. In various examples, the submission procedure may be electronic, non-electronic, and/or a combination of both.

The developer can comment on these ideas and the community may rank the ideas through a ranking system. After an idea reaches a certain popularity threshold, the developers may take the idea and flesh out a pitch to incorporate it into the software/product/device/game/service. Each approved pitch will be submitted for voting for a specified period of time. Consumers may then purchase a digital currency with real money, and use that currency to fund a pitch. If the pitch reaches funding, then the digital currency will be consumed, the pitch will be added to the development roadmap, and the developers will create a project plan. People who funded the pitch may be able to use their influence points to influence its creation. If it is not funded, then everyone who put the digital currency into the object to fund it may receive it back.

Additionally, the influence system, device, and/or method may serve to create an economy around consumers influencing and funding a software/product/device/game/service. Consumer/player/user/purchaser may be able to trade the influence points and funding currency, which will create a market based around influencing the software/product/device/game/service and funding new features for the software/product/device/game/service.

Further, influence system, device, and/or method may allow players and/or user to spend time using software/product/device/game/service to earn points that allows the player and/or user to vote on the direction of the software/product/device/game/service.

In addition, the funding system, device, and/or method may allow users and/or players to spend real money (virtual currency and/or project currency) to crowd fund individual features of a piece of software/product/device/game/service.

Further, the suggestion system, device, and/or method may create ideas (and/or comments) for a software/product/device/game/service. This is a multi-step process which allows users to submit an idea. After the idea is submitted, the idea may be approved for development by the development team and then the community curates and comments on the ideas. When ideas rise to the top they are turned into pitches for the voting and/or funding system.

In addition, the roadmap system, device, and/or method may aggregate all of the development tasks on a software/product/device/game/service for users to view. It distinguishes between features that were funded by developers and features that were funded by crowdfunding (See FIG. 7A, reference numbers 711, 713, 715, and 717). This roadmap uses internal tools to stay updated with the development of the software, so at any time users can see the development progress of the software in sum.

Community Platform—All of these systems are fully integrated into a community platform where people can discuss the software/product/device/game/service and the software/product/device/game/service features.

No other platform turns the act of making decisions about a products future based on a system, device, and/or method that is a function of the time/quantity purchased/usage/a consumer/player/user/purchaser spends in the software/product/device/game/service. This provides a distinct advantage of allowing the software/product/device/game/service to evolve weighted to decisions of the consumer/player/user/purchaser using the software/product/device/game/service the most.

Similarly, no other platform provides a means for users to directly fund additional features for it after release. This provides a brand new mechanism for people to pay for a live product. Instead of purchasing a subscription to gain access to the product or spending money on micro transactions, they can directly fund the product's ongoing development on a feature-by-feature basis.

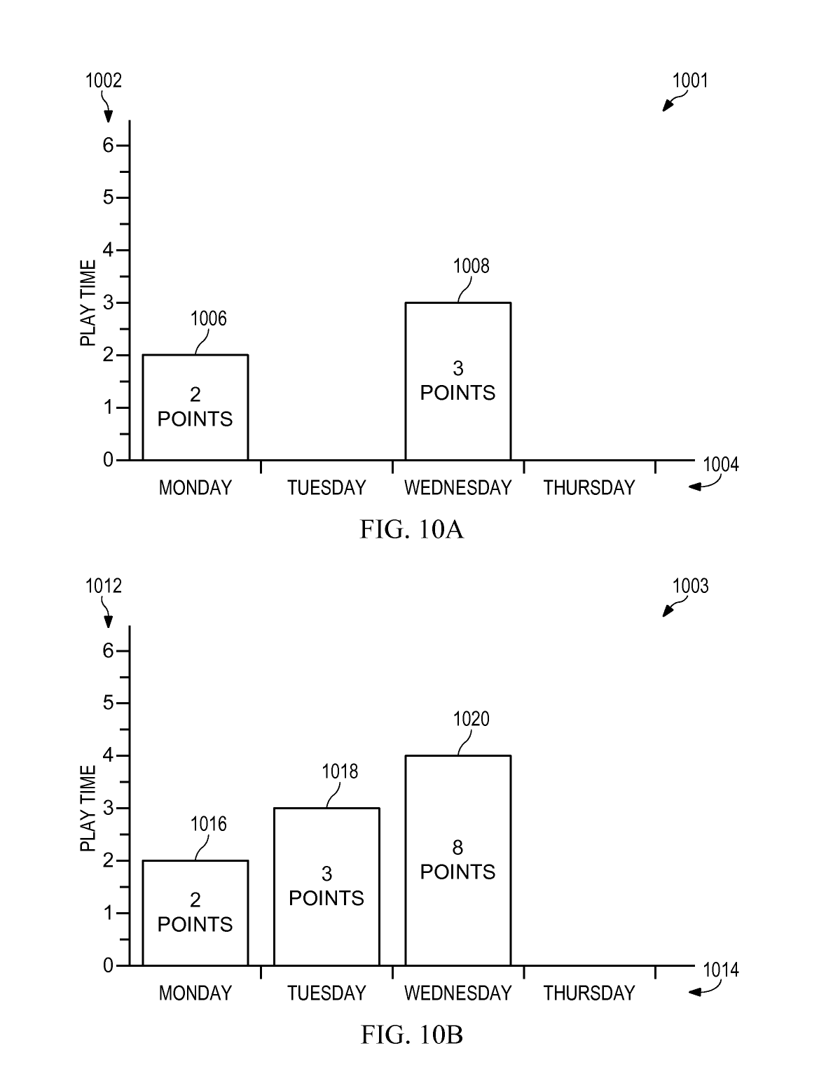

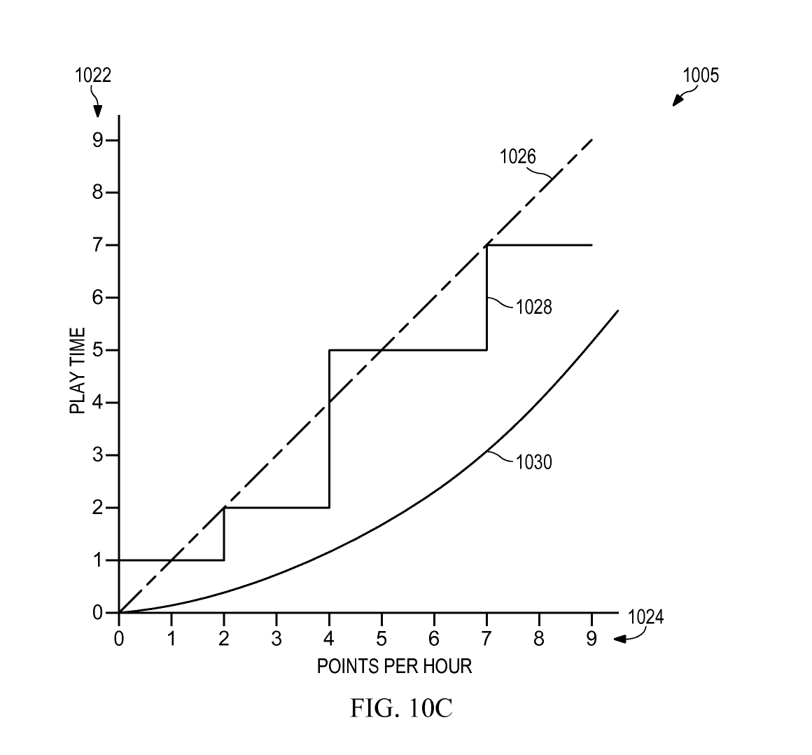

In FIG. 10A, an illustration of earning votes and/or influence criteria is shown, according to one embodiment. A first table image 1001 includes a time period scale 1004 and a play time scale 1002. It should be noted that the play time scale 1002 could be a number of times bought, number of times utilized, frequency of utilization, time period for playing, etc. Further, the time period scale 1002 may be in seconds, minutes, hours, days, weeks, months, years, etc. In this example, a player that plays during a first time period 1006 (e.g., a Monday) may earn 1 point per hour played (in other words, the player played for two hours and earned 2 points). Since the player skipped a day (e.g., a second time period—Tuesday), the player earned the same 1 point per hour played when the player played during a third time period (e.g., Wednesday). Therefore, since the player played for 3 hours, the player would have earned 3 points.

In FIG. 10B, another illustration of earning votes and/or influence criteria is shown, according to one embodiment. A second table image 1003 may show that a player earned one point per hour of game play during a first time period 1016 and a second time period 1018. Therefore, the player earned 2 points during the first time period 1016 (earned one point an hour for two hours of play) and the player earned 3 points during the second time period 1018 (earned one point per hour for three hours of play). However, since the player has played on three consecutive days, the player earned 2 points per hour of game play during a third time period 1020. Therefore, the player earned 8 points for four hours of game play during the third time period 1020 (e.g., Wednesday).

In FIG. 10C, another illustration of earning votes and/or influence criteria is shown, according to one embodiment. In this example, a first point earning line 1026 can be linear, a second point earning line 1028 can be a step function, a third point earning line 1030 can be logarithmic, and/or any other algorithm can be utilized.

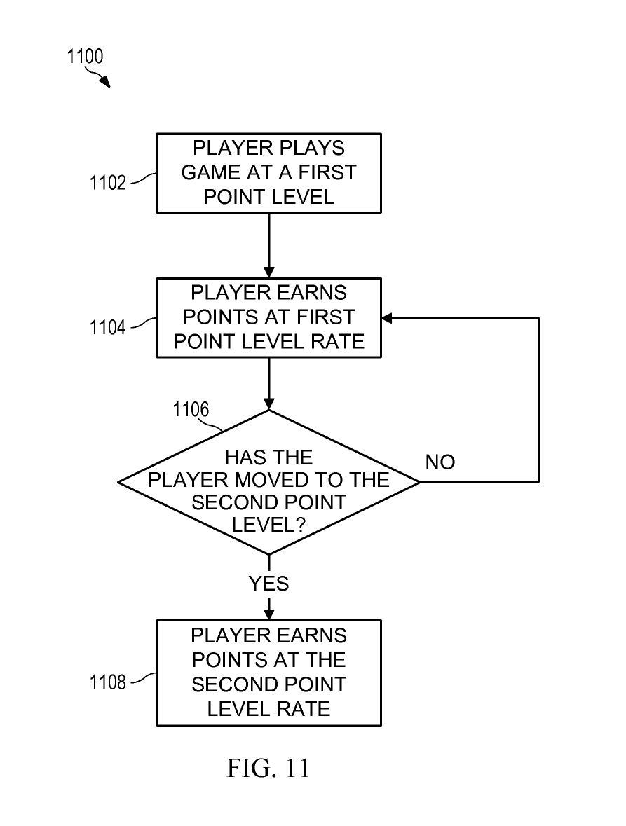

In FIG. 11, a flow diagram is shown, according to one embodiment. The method may include the player playing a game at a first point earning level (step 1102). The method may include the player earning points at the first point earning level rate (step 1104). The method may include the system, device, and/or method determining whether the player has moved to the second point earning level (step 1106). If the player has not moved to the next point earning level, the method moves back to step 1104. If the player has moved to the next point earning level, then the method may allow the player to earn points for game play at the second point earning level. For example, when a player plays for the first three hours of play, the player may earn 1 point for hour—therefore the player earns 3 points for this specific playing time. However, if the player keeps playing, the player earns 2 points per hour. Therefore, if the player plays for 2 more hours, the player will earn 4 additional points. In this case, the player earns a total of 7 points for playing 5 total hours of game play. In another example, a person may earn voting points (e.g., 1 vote) for every $1 spent and then the person may earn voting points (e.g., 2 votes) for every $1 spent over $100. This may be in total and/or during a predetermined time frame (e.g., a day, a week, two weeks, a month, etc.).

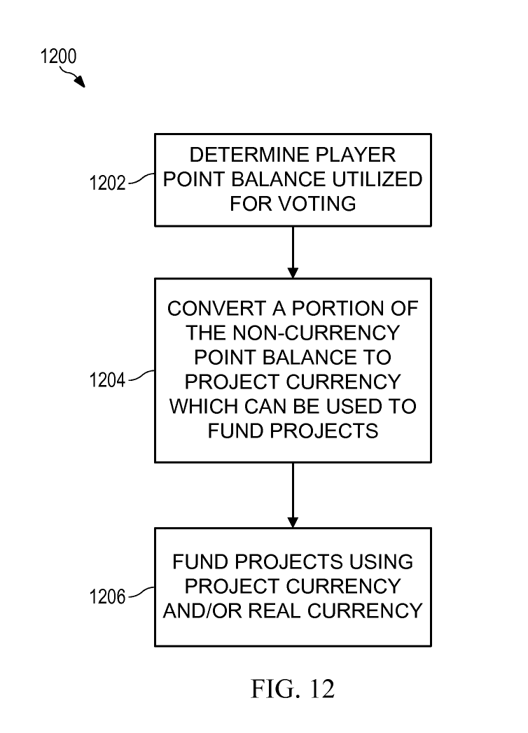

In FIG. 12, a flow diagram is shown, according to one embodiment. The method may include determining whether the player's point balance was utilized for voting (step 1202). The method may include converting a portion of the non-currency point balance to project currency which can be used to fund projects (step 1204). The method may include funding projects utilizing the project currency and/or or real currency (step 1206). In one example, the player may have earned 1,000 votes and may be able to convert all and/or a portion of these earned votes into project currency and/or real currency. In this example, the player may convert 100 votes into $100 of project currency and/or real currency (and/or any other number $1, $10, $50, etc.). In this example, the project currency can be used to fund one or more projects. Further, the real currency may be used to purchase one or more services, games, products, and/or devices.

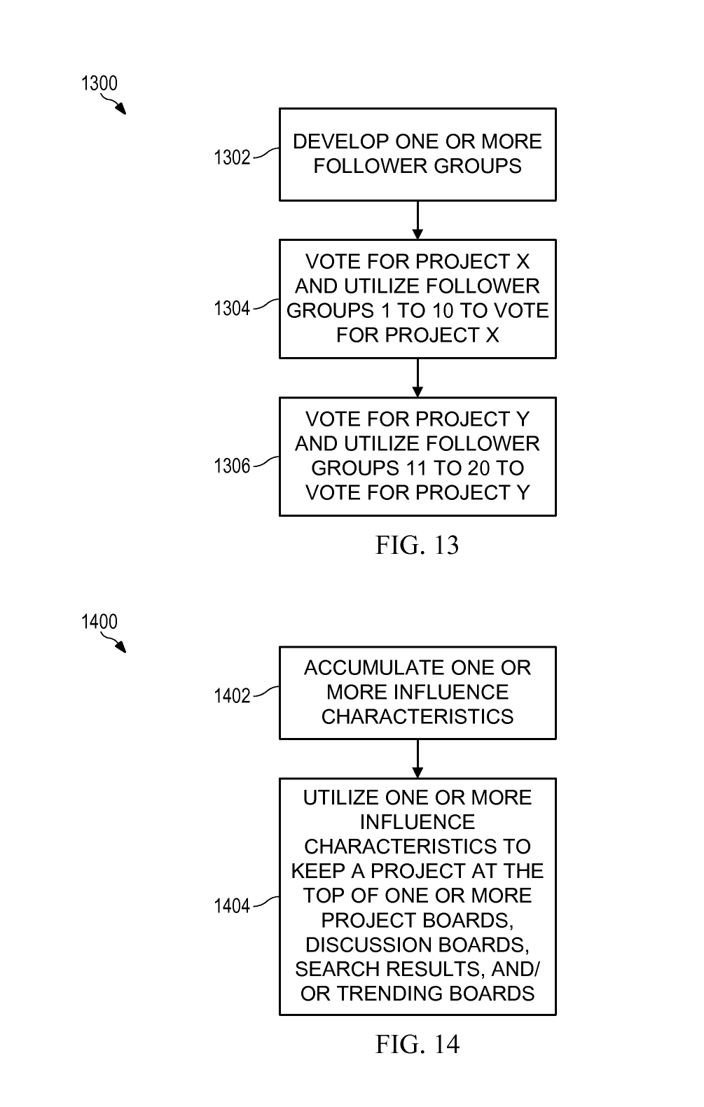

In FIG. 13, a flow diagram is shown, according to one embodiment. The method may include developing one or more follower groups (step 1302). The method may include voting for project X and utilizing follower groups 1 to 10 (and/or any number of follower groups) to vote for project X (step 1304). The method may include voting for project Y and utilizing follower groups 11 to 20 to vote for project Y (step 1306). In one example, a person may have one or more followers based on one or more criteria. The followers may allow the leader to case and/or place one or more votes for the follower. In this example, the leader has utilized followers 1-10 to vote for a specific project while the leader has utilized follower groups 11-10 to vote for a different project.

In FIG. 14, a flow diagram is shown, according to one embodiment. The method may include accumulating one or more influence characteristics (step 1402). The method may include utilizing one or more influence characteristics to keep a project at the top of one or more project boards, discussion boards, search results, and/or trending boards (step 1404). In various examples, a person may have certain influence characteristics (e.g., followers, number of voting procedures participated in, number of funding procedures participated in, number of hours played, number of products bought, total amount spent, etc.) which can be utilized to place a project at the top of one or more leaderboards, project boards, searching results, trending topic, any other communication vehicle, and/or any combination thereof.

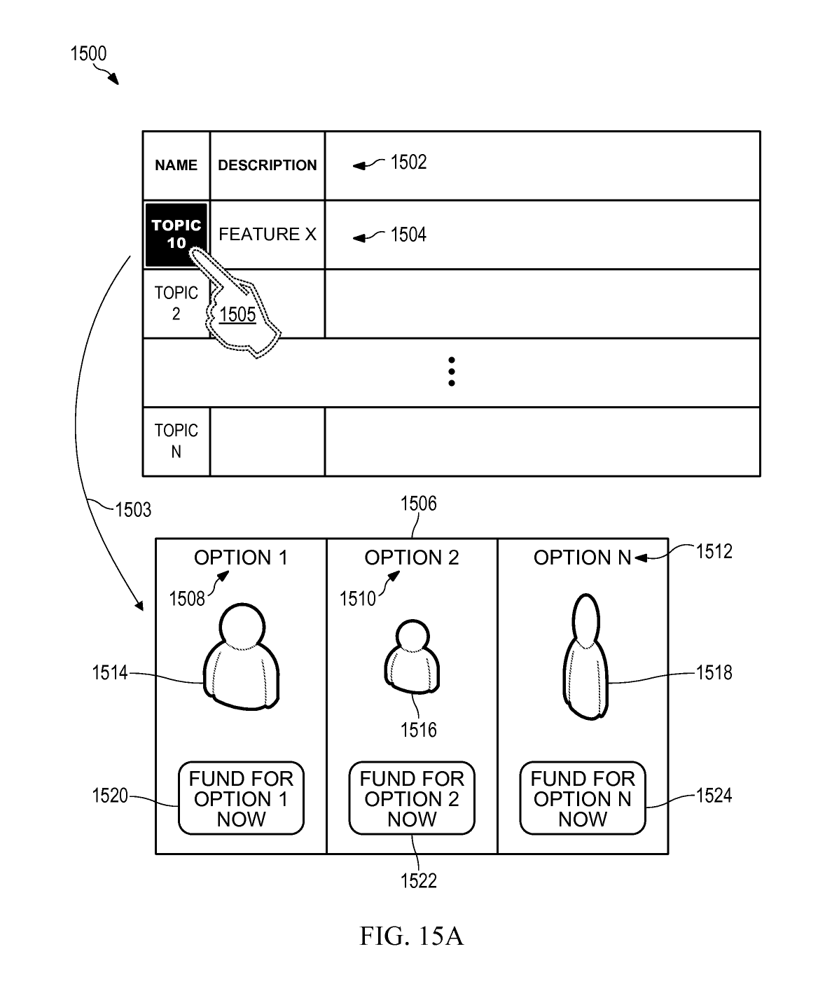

In FIG. 15A, another illustration of an influence procedure for a product is shown, according to one embodiment. A first funding image 1500 may include a project list box 1502 and a second project details 1504. After selecting the second project, a second project options screen 1506 is shown. Second project options screen 1506 may include a first option 1508, a second option 1510, and an Nth option 1512. First option 1508 may include a first icon 1514 which is a first character. Second option 1510 may include a second icon 1516 which is a second character. Nth option 1512 may include an Nth icon 1518 which is a third character. Further, a first funding button 1520 may be utilized to make a funding pledge for the first option. In addition, a second funding button 1522 may be utilized to make a funding pledge for the second option. Lastly, a third funding button 1524 may be utilized to make a funding pledge for the Nth option.

In FIG. 15B, another illustration of an influence procedure for a product is shown, according to one embodiment. A second funding image 1530 may include a project list box 1532 and a second project details 1534. After selecting the second project, a second project options screen 1536 is shown. Second project options screen 1536 may include a first weapon option 1538, a second weapon option 1540, and an Nth weapon option 1542. First weapon option 1538 may include a first weapon icon 1544 which is a fun. Second weapon option 1540 may include a second weapon icon 1546 which is a flail. Nth weapon option 1542 may include an Nth weapon icon 1548 which is a bow. Further, a first funding button 1550 may be utilized to make a funding pledge for the first option. In addition, a second funding button 1552 may be utilized to make a funding pledge for the second option. Lastly, a third funding button 1554 may be utilized to make a funding pledge for the Nth option.

In FIG. 15C, another illustration of a funding procedure for a product is shown, according to one embodiment. A third funding image 1560 may include a project list box 1562 and a first project details 1564. After selecting (reference numbers 1565 and 1561) the first project, a first project options screen 1566 is shown. First project options screen 1566 may include a first art option 1568, a second art option 1570, and an Nth art option 1572. First art option 1568 may include a first art icon 1574 with a first art configuration. Second art option 1570 may include a second art icon 1576 with a second art configuration. Nth art option 1572 may include an Nth art icon 1578 with an Nth art configuration. Further, a first funding button 1580 may be utilized to fund and/or pledge money for the first art option 1568. In addition, a second funding button 1582 may be utilized to fund and/or make a pledge for the second art option 1570. Lastly, a third funding button 1584 may be utilized to fund and/or make a pledge for the Nth ad option 1572.

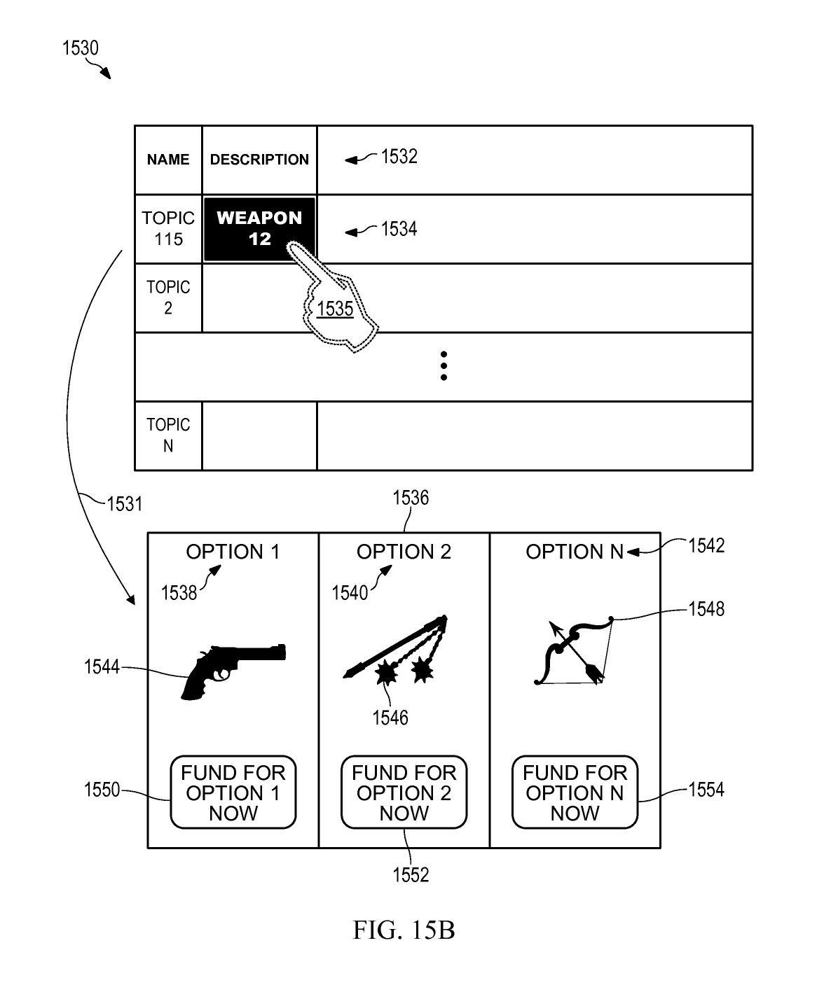

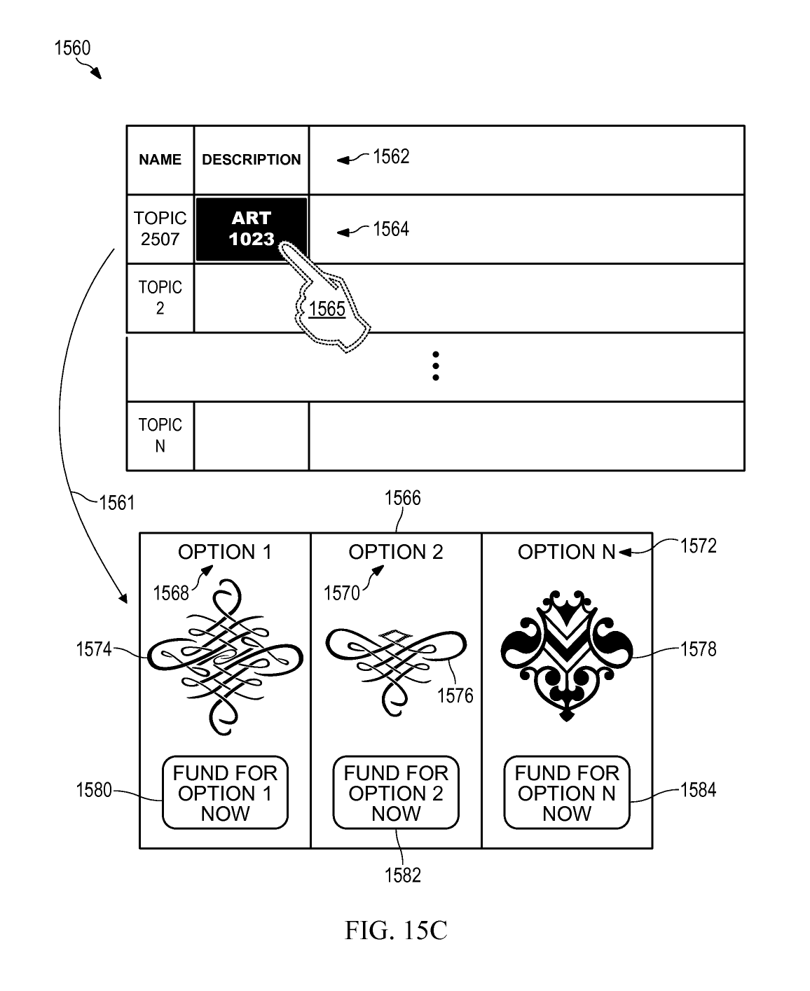

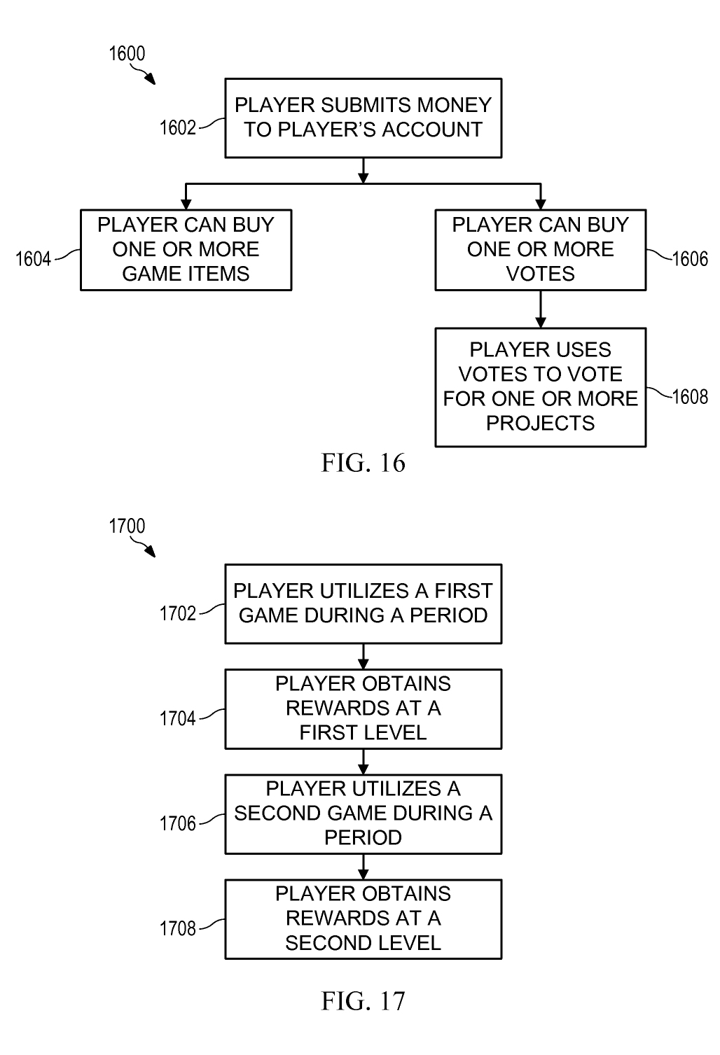

In FIG. 16, a flow diagram is shown, according to one embodiment. The method may include the player submitting money to the player's account (step 1602). The method may include the player buying one or more game items with the submitting money (step 1604). The method may include the player buying one or more votes with the submitting money (step 1606). The method may include the player utilizing one or more purchased votes to vote for one or more projects (step 1608). In addition, the method may include the player funding one or more projects with the submitted money. In one example, a player may submit $100.00 to his account to increase his account balance from 0 to $100.00. The player may utilize $50.00 of this balance to purchase one or more items (e.g., a game, a product, a service, and/or any combination thereof). The player may utilize $50.00 of this balance to purchase 500 votes which the player can utilize to vote for one or more projects.

In FIG. 17, a flow diagram is shown, according to one embodiment. The method may include the player utilizing a first game a first period (step 1702). The method may include the player obtaining rewards at a first level (step 1704). The method may include the player utilizing a second game during a second period (step 1706). The method may include the player obtaining rewards at a second level (step 1708). In one example, the first period and the second period are the same period. In another example, the first period and the second period are different periods. In another example, the first period and the second period have some overlapping time. In one example, when a player only plays a first game the player earns votes at a first rate (e.g., 1) but when the player plays both a first game and a second game, the player earns votes at a second rate (e.g., 2). In another example, when a person buys a first product, the person earns votes at a first rate (e.g., 1) but when the person buys both a first product and a second product, the person earns votes at a second rate (e.g., 3). This feature may help to cross sell one or more products.

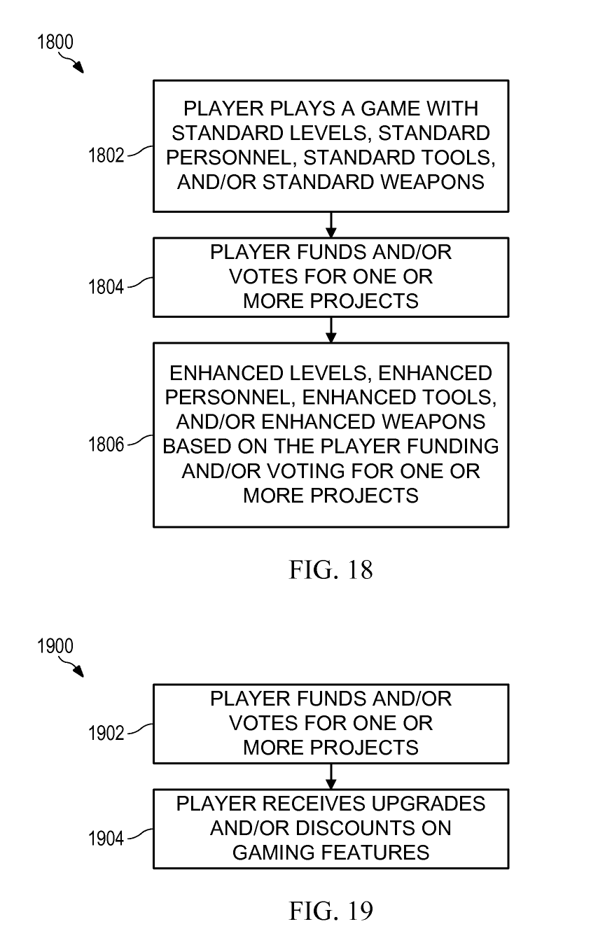

In FIG. 18, a flow diagram is shown, according to one embodiment. The method may include the player playing a game with standard levels, standard personnel, standard tools, and/or standard weapons (step 1802). The method may include the player funding and/or voting for one or more projects (step 1804). The method may include the system, device, and/or method enhancing the game levels, the player levels, personnel, tools, weapons, and/or any other feature based on the player funding and/or voting for one or more projects. In one example, a player may receive a first bonus game level based on the player funding and/or voting for one or more projects. In another example, a person may receive a free gift, rushed delivery, free delivery, and/or a discount on a purchase based on the player funding and/or voting for one or more projects.

In FIG. 19, a flow diagram is shown, according to one embodiment. The method may include the player funding and/or voting for one or more projects (step 1902). The method may include the player receiving upgrades and/or discounts on gaming features based on the player funding and/or voting for one or more projects.

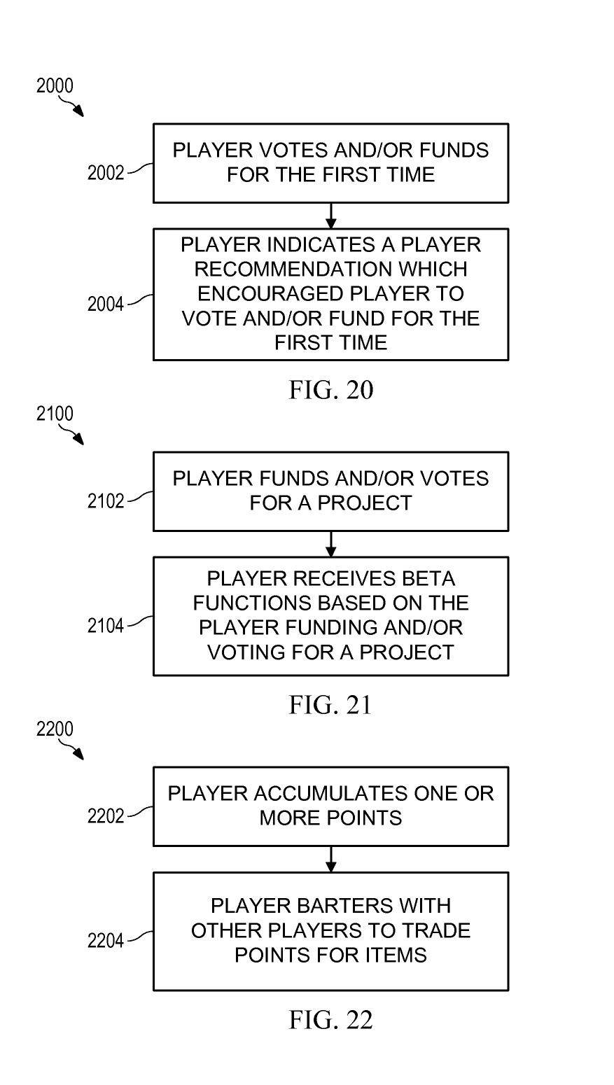

In FIG. 20, a flow diagram is shown, according to one embodiment. The method may include the player voting and/or funding for the first time (step 2002). This could also be voting and/or funding for the first time in a specific time period—in other words, not voting for the last 3 months and now voting may be the same as voting for the first time and/or may be treated differently than voting on a regular basis. The method may include the player indicating that another player recommended that this player vote and/or fund which encouraged the player to vote and/or fund a project for the first time (step 2004). In one example, the recommending player will receive a reward, a gift, a discount, project currency, virtual currency, real currency, additional votes, any item of value, and/or any combination thereof.

In FIG. 21, a flow diagram is shown, according to one embodiment. The method may include the player funding and/or voting for a project (step 2102). The method may include the player receiving a beta functionality based on the player funding and/or voting for a project (step 2104). In one example, a player which funds and/or votes for an approved project may receive a beta version of the game, product, service, and/or device to test out and provide additional feedback. In addition, the player may receive a discount on the purchase of the game, product, service, and/or device when it is fully released.

In FIG. 22, a flow diagram is shown, according to one embodiment. The method may include the player accumulating one or more points (step 2202). The method may include the player bartering with other players to trade the points for items (e.g., currency, tools, upgrades, etc.) (step 2204). In one example, a player may trade a gold pieces earned in a first game to a second player for a weapon and/or votes and/or virtual currency, and/or project currency, and/or points.

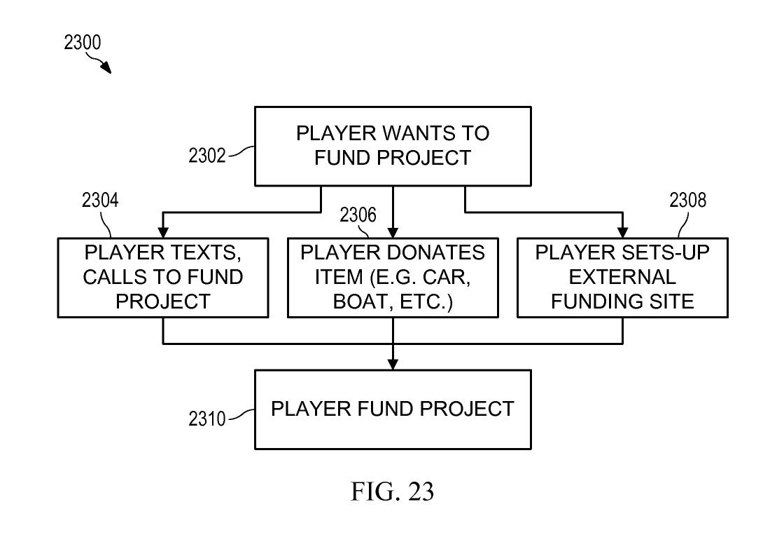

In FIG. 23, a flow diagram is shown, according to one embodiment. The method may include the player wanting to fund a project (step 2302). The method may include the player texts and/or calls to fund a project (step 2304). The method may include the player donating items (e.g., a car, a computer, a boat) to a funding source to fund a project (step 2306). The method may include the player setting up external funding site to fund a project (step 2308). The method may include the player funding the project (step 2310). In one example, a player may fund a project by placing a text and/or calling a number where part of the money generated by texting and/or calling is utilized to fund a project. In another example, the player may establish a funding site to generate donates and/or pledges which are utilized to fund a project.

In one embodiment, the system for voting on one or more projects may include one or more memory devices and one or more processors. The one or more processors may receive at least a first project; present the first project to a voting community; receive one or more votes relating to the first project from one or more members of the voting community; and/or determine a status of the first project based on the received votes.

In one example, the first project may have been submitted by an internal company source, a customer of a company, and/or a third party source. Further, the first project may have been determined and/or screened by comparing a first project details to one or more criteria. In addition, the one or more processors may generate a first project condition for the first project. Further, the first project condition may be that the first project is approved to move to a funding stage. In another example, the one or more processors may generate a second project condition for the first project. Further, the second project condition may be that the first project is approved to an implementation stage. In addition, the one or more processors may generate a third project condition for the first project. Further, the third project condition may be that the first project has been rejected. In another example, the one or more processors may generate a fourth project condition for the first project. In addition, the fourth project condition may be that the first project is still pending and/or active. In one example, the one or more processors may generate an action plan based on a first project approval. Further, the action plan may have a plurality of action items. In addition, the one or more processors may cause a display of details relating to the first project on one or more community boards.

In another embodiment, the method of voting on one or more projects may include: receiving via one or more processors at least a first project; presenting via the one or more processors the first project to a voting community; receiving via the one or more processors one or more votes relating to the first project from one or more members of the voting community; and/or determining via the one or more processors a status of the first project based on the received votes.

In another example, the first project may have been submitted by an internal company source, a customer of a company, and/or a third party source. Further, the first project may be determined and/or screened by comparing a first project details to one or more criteria. In addition, the method may further include generating a first project condition for the first project. In another example, the first project condition may be that the first project is approved to move to a funding stage. The method may include generating a second project condition for the first project.

In another embodiment, the system for funding on one or more projects may include one or more memory devices and one or more processors. The one or more processors may receive at least a first project; present the first project to a funding community; receive one or more funding pledges relating to the first project from one or more members of the funding community; and/or determine a status of the first project based on the received pledged funds.

In another example, the first project may be submitted by an internal company source, a customer of a company, and/or a third party source. In addition, the first project may be determined and/or screened by comparing a first project details to one or more criteria. Further, the one or more processors may generate a first project condition for the first project where the first project condition may be that the first project is approved to move to a implementation stage. In addition, the one or more processors may generate a second project condition for the first project where the second project condition may be that the first project is completed. In another example, the one or more processors may generate a third project condition for the first project where the third project condition may be that the first project has been rejected. In addition, the one or more processors may generate a fourth project condition for the first project where the fourth project condition may be that the first project is still pending and/or active. In another example, the one or more processors may generate an action plan based on a first project funding approval where the action plan has a plurality of action items. In addition, the one or more processors may cause a display of details relating to the first project on one or more community boards.

In another example, the method of funding on one or more projects may include: receiving via one or more processors at least a first project; presenting via the one or more processors the first project to a funding community; receiving via the one or more processors one or more funding pledges relating to the first project from one or more members of the funding community; and/or determining via the one or more processors a status of the first project based on the received funding pledges.

Further, the first project may be submitted by an internal company source, a customer of a company, and/or a third party source. In addition, the first project may be determined and/or screened by comparing a first project details to one or more criteria. In addition, the method may include generating a first project condition for the first project where the first project condition may be that the first project is approved to move to an implementation phase. In one example, the method may further include comprising generating a second project condition for the first project.

In another embodiment, the system, device, and/or method for funding one or more projects may include one or more processors configured to receive a first project characteristics, where the one or more processors are configured to communicate the first project characteristics to a plurality of entities to obtain funding for the first project where the funding is a predetermined dollar amount, the processors may be further configured to receive funding pledges from the plurality of entities which creates a first project pledging amount during a first period of time, and the processors further configured to determine a status of the first project based on a comparison of the total first project funding pledges versus the predetermined dollar amount and the processors configured to determine a first project approval status based on the first project funding pledges being greater than the predetermined dollar amount (e.g., fully funded and approved). In addition, the first project approval status may be denied based on the first project funding pledges being less than the predetermined dollar amount. Further, the project status may be active and/or pending if the first project funding pledges are less than the predetermined dollar amount but the funding period has not expired. In addition, once a project has been funded and/or approved, an action plan detailing the steps necessary to complete the product, device, service, and/or game may be created. Further, if the funding pledges excess the predetermined dollar amount, then new features may be added and/or excess funds may be returned to the pledgers. In addition, all non-funded projects may be achieved, reformulated, resubmitted, and/or combined with other projects.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples. While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more options may be Internet based options. Therefore, all of the examples and/or embodiments may be utilized via an Internet based system.

1. A system for funding on one or more projects comprising:
one or more memory devices;
one or more processors configured to receive at least a first project, the one or more processors configured to present the first project to a funding community, the one or more processors configured to receive one or more funding pledges relating to the first project from one or more members of the funding community, the one or more processors configured to determine a status of the first project based on the received pledged funds.

2. The system of claim 1, wherein the first project was submitted by at least one of an internal company source, a customer of a company, and a third party source.

3. The system of claim 1, wherein the first project was determined by comparing a first project details to one or more criteria.

4. The system of claim 1, wherein the one or more processors are configured to generate a first project condition for the first project.

5. The system of claim 5, wherein the first project condition is that the first project is approved to move to an implementation stage.

6. The system of claim 1, wherein the one or more processors are configured to generate a second project condition for the first project.

7. The system of claim 6, wherein the second project condition is that the first project is completed.

8. The system of claim 1, wherein the one or more processors are configured to generate a third project condition for the first project.

9. The system of claim 8, wherein the third project condition is that the first project has been rejected.

10. The system of claim 1, wherein the one or more processors are configured to generate a fourth project condition for the first project.

11. The system of claim 10, wherein the fourth project condition is that the first project is still pending and/or active.

12. The system of claim 1, wherein the one or more processors are configured to generate an action plan based on a first project funding approval.

13. The system of claim 12, wherein the action plan has a plurality of action items.

14. The system of claim 1, wherein the one or more processors are configured to cause a display of details relating to the first project on one or more community boards.

15. A method of funding on one or more projects comprising:
receiving via one or more processors at least a first project;
presenting via the one or more processors the first project to a funding community;
receiving via the one or more processors one or more funding pledges relating to the first project from one or more members of the funding community; and
determining via the one or more processors a status of the first project based on the received funding pledges.

16. The method of claim 15, wherein the first project was submitted by at least one of an internal company source, a customer of a company, and a third party source.

17. The method of claim 15, wherein the first project was determined by comparing a first project details to one or more criteria.

18. The method of claim 15, further comprising generating a first project condition for the first project.

19. The method of claim 18, wherein the first project condition is that the first project is approved to move to an implementation phase.

20. The method of claim 15, further comprising generating a second project condition for the first project.
